(19) United States
(12) Patent Application Publication
(10) Pub. No.: US 2026/0238591 A1
(43) Pub. Date: Aug. 13, 2026

(54) COMMUNICATION CONFIGURATION FOR PERSONAL IOT NETWORK

(71) Applicant: GOOGLE LLC, Mountain View, CA (US)

(72) Inventor: Ching-yu Liao, Mountain View, CA (US)

(21) Appl. No.: 19/471,351

(22) PCT Filed: Apr. 1, 2024
(86) PCT No.: PCT/US24/22563

§ 371 Date: Sep. 30, 2025

Related U.S. Application Data
(60) Provisional application No. 63/493,723, filed on Mar. 31, 2023.
(60) Provisional application No. 63/495,074, filed on Apr. 7, 2023.

(51) Int. Cl. H04L 45/74

(52) U.S. Cl. CPC H04L 45/74

(57) ABSTRACT

A method implemented in a user equipment (UE), the method comprising: serving a personal internet-of-things (IoT) network (PIN) element (PINE) associated with a PIN, to provide a direct connection between the PINE and the UE operating as a PINE with gateway capability (PEGC); receiving, at the UE via a core network (CN), an Internet Protocol (IP) packet; routing the IP packet to the PINE in view of a header of the IP packet.

### CROSS-REFERENCE TO RELATED APPLICATIONS

This application claims priority to and the benefit of the filing date of (1) provisional U.S. Patent Application No. 63/493,723 entitled “METHOD OF HANDLING COMMUNICATION CONFIGURATION FOR PERSONAL IOT NETWORK,” filed on Mar. 31, 2023, and (2) provisional U.S. Patent Application No. 63/495,074 entitled “METHOD OF HANDLING COMMUNICATION CONFIGURATION FOR PERSONAL IOT NETWORK IN 5G SYSTEM,” filed on Apr. 7, 2023. The entire contents of the provisional applications are hereby expressly incorporated herein by reference.

### FIELD OF THE DISCLOSURE

This disclosure relates generally to methods, devices, and articles in wireless communication systems, such as 3GPP communication systems, and in particular to processing personal internet-of-things (IoT) network (PIN) traffic.

### BACKGROUND

This background description is provided for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

Generally, within a Personal IoT Network (PIN), a PIN Element with Gateway Capability (PEGC) is capable of providing 5G connectivity for PIN Elements (PINEs) connected to the PEGC (i.e., “behind the PEGC”). The PEGC allows PINEs within the same PIN communicating with each other across different PEGCs with PEGC via a 5G Core Network (CN).

A PIN may include at least one PEGC. A PEGC may support one or more PINs. A PEGC is a PIN member. A PINE may be a 3GPP user equipment (UE) (e.g., using sidelink communication over a PC5 interface) or a non-3GPP device (e.g., using Wi-Fi, Bluetooth) that is connected to a PEGC. A non-3GPP device may support IP-based connectivity (e.g., Wi-Fi, Bluetooth Low Energy) or non-IP-based connectivity (e.g., Bluetooth).

However, direct communication between an IP-based device and a non-IP-based device is only possible by routing a PIN traffic locally at a PEGC. Although there can be more than one PEGCs in a PIN, it is not clear how devices can implement PINE-to-PINE communication across different PEGCs via a 5G CN.

In the scenarios where there are multiple PINs in a public land mobile network (PLMN) and multiple PEGCs within a PIN, there is no clear mechanism, for either a PEGC or a CN, to identify a PIN and a PINE connected to a PEGC, for the purposes of routing a PIN traffic to a destination PINE connected to a PEGC. Additionally, there is no clear mechanism for coordinating PIN communication configuration information among a PEGC, various network functions (NFs) of a CN, and/or functions provided by third-party entities.

### SUMMARY

An example embodiment of the techniques of this disclosure is a method implemented in a user equipment (UE), the method comprising: serving a personal internet-of-things (IoT) network (PIN) element (PINE) associated with a PIN, to provide a direct connection between the PINE and the UE operating as a PINE with gateway capability (PEGC); receiving, at the UE via a core network (CN), an Internet Protocol (IP) packet; and routing the IP packet to the PINE in view of a header of the IP packet.

Another example embodiment of these techniques is a method implemented in a network function (NF) of a core network (CN), the method comprising: receiving, at the NF, a personal internet-of-things (IoT) network (PIN) communication configuration including (i) an identifier of a PIN, (ii) a UE ID to identify a user equipment (UE) operating as a PIN element (PINE) with gateway capability (PEGC) and associated with the PIN, and (iii) a PINE ID to identify the PINE within a PIN subgroup of the PEGC; and configuring the CN for routing IP packets addressed to the PINE.

Yet another example embodiment of these techniques is a user equipment (UE), comprising a transceiver and processing hardware, the UE configured to implement one of the methods above.

### BRIEF DESCRIPTION OF THE DRAWINGS

FIG. 1 is a block diagram of an example wireless communication system that can implement one or more of the techniques of this disclosure for handling PINE-to-PINE communications.

FIG. 2 is a block diagram of an example protocol stack according to which the UE of FIG. 1 can communicate with the RAN of FIG. 1.

FIG. 3 is a service-based representation of the CN architecture, which the system of FIG. 1 can implement.

FIG. 4 is a reference-point based representation of the CN architecture, which the system of FIG. 1 can implement.

FIG. 5 is a flow diagram of an example method for identifying a destination PINE.

FIG. 6 illustrates components of an example IPv6 header, which a UE and/or a NF of this disclosure can use to route PIN traffic.

FIG. 7 is a messaging diagram of an example process for coordinating UE-based PIN communication configuration information.

FIG. 8 is a flow diagram of an example method for coordinating UE-based PIN communication configuration information.

FIG. 9 is a messaging diagram of another example process for coordinating UE-based PIN communication configuration information.

FIG. 10 is a flow diagram of an example method for coordinating UE-based PIN communication configuration information.

FIG. 11 is a messaging diagram of an example process for coordinating UDM-based PIN communication configuration information.

FIG. 12 is a flow diagram of an example method for coordinating UDM-based PIN communication configuration information.

FIG. 13 is a messaging diagram of another example process for coordinating UDM-based PIN communication configuration information.

FIG. 14 is a flow diagram of an example method for coordinating UDM-based PIN communication configuration information.

FIG. 15 is a messaging diagram of yet another example process for coordinating UDM-based PIN communication configuration information.

FIG. 16 is a flow diagram of an example method for coordinating UDM-based PIN communication configuration information.

FIG. 17 is a messaging diagram of an example process for coordinating AF-based PIN communication configuration information, according to some implementations.

FIG. 18 is a flow diagram of an example method for coordinating AF-based PIN communication configuration information.

FIG. 19 is a messaging diagram of another example process for coordinating AF-based PIN communication configuration information.

FIG. 20A is a messaging diagram of an example process for PIN communication using framed routing.

FIG. 20B is a messaging diagram following FIG. 20A.

FIG. 21 is a flow diagram for PIN communication using framed routing.

### DETAILED DESCRIPTION OF THE DRAWINGS

The devices discussed below support PIN communication configuration information for PINE-to-PINE communication. As will be described below in detail, the PIN communication configuration information includes necessary information for identifying a PIN and a PINE for routing PIN traffics. The disclosure further provides how PIN communication configuration is information is generated and coordinated among a PEGC (e.g., UE) and various NFs of a CN.

As used herein, PINE-to-PINE communication is communication between two PINEs. The communication may be PINE-to-PINE direct communication or PINE-to-PINE indirect communication.

As used herein, PINE-to-PINE direct communication is communication between two PINEs without PEGC, any 3GPP RAN, or a UPF in the middle.

As used herein, PINE-to-PINE indirect communication is communication between two PINEs via PEGC or via PEGC and a UPF.

While this disclosure uses 5G networks as an example, one will appreciate that the principles of this disclosure generally apply to 3G networks, 4G networks, 6G networks, and future generations of networks.

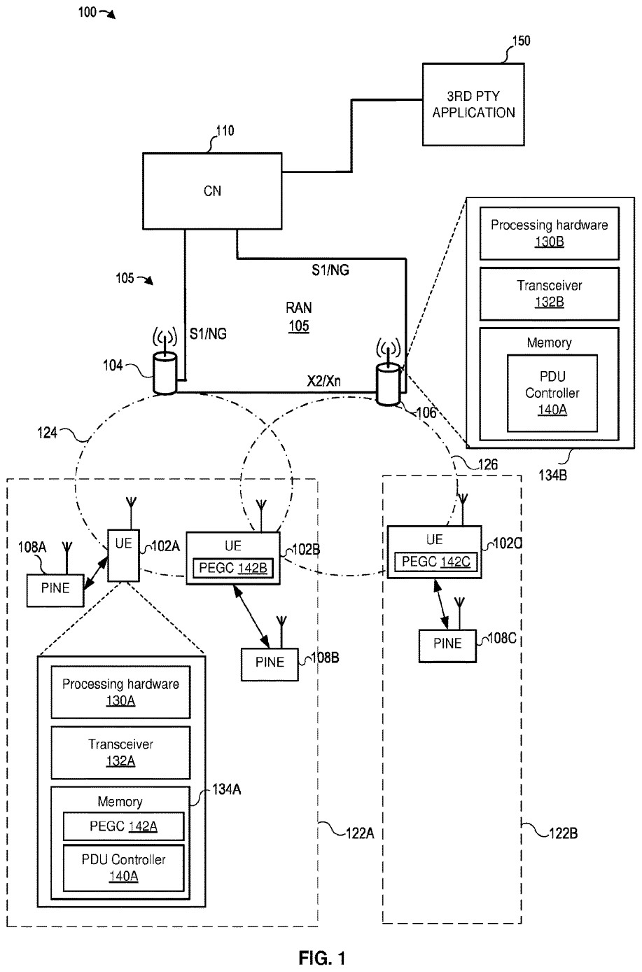

Referring first to FIG. 1, an example wireless communication system 100 can implement one or more of the techniques of this disclosure for handling PINE-to-PINE communications. The example wireless communication system 100 includes UEs 102A, 102B, and 102C, PINEs 108A, 108B, and 108C, a base station (BS) 104, a base station 106, and a core network (CN) 110, such as a fifth generation (5G) core (5GC). The base stations 104 and 106 can operate in a RAN 105 connected to the CN 110. The CN 110 can also be implemented as a sixth generation (6G) core or another suitable core network.

The base station 104 covers a cell 124, and the base station 106 covers a cell 126. If the base station 104 is a gNB, the cell 124 is an NR cell. If the base station 124 is an ng-eNB, the cell 124 is an evolved universal terrestrial radio access (E-UTRA) cell. Similarly, if the base station 106 is a gNB, the cell 126 is an NR cell, and if the base station 126 is an ng-eNB, the cell 126 is an E-UTRA cell. The cells 124 and 126 can be in the same Radio Access Network Notification Areas (RNA) or different RNAs. The cells 124 and 126 can partially overlap, so that the UE 102A, 102B, or 102C can select, reselect or hands over from one of the cells 124 and 126 to the other. In general, the RAN 105 can include any number of base stations, and each of the base stations can cover one, two, three, or any other suitable number of cells. The UE 102 can support at least a 5G NR (or simply, “NR”) air interface to communicate with the base stations 104 and 106. Each of the base stations 104, 106 can connect to the CN 110 via an interface (e.g., S1 or NG interface). The base stations 104 and 106 also can be interconnected via an interface (e.g., X2 or Xn interface) for interconnecting NG RAN nodes.

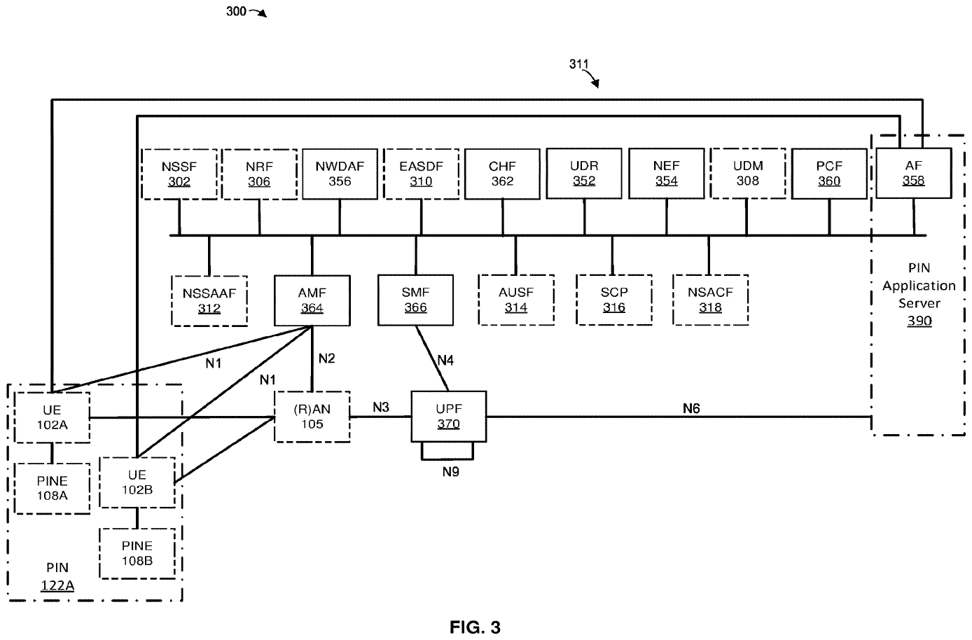

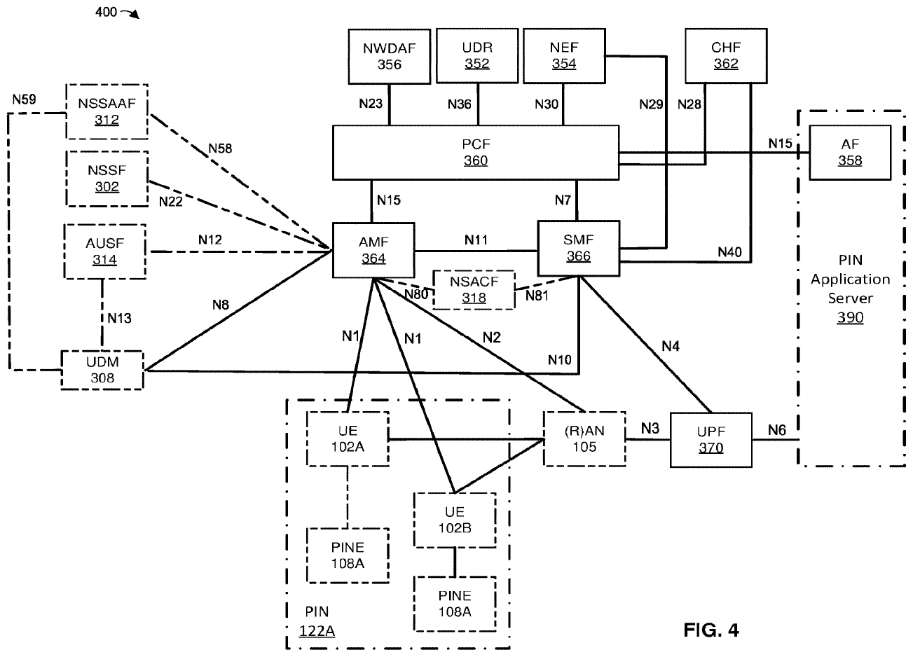

Several network functions (NFs) that make up the CN 110 are discussed below with reference to FIGS. 3 and 4. One or more of the NFs of the CN 110 coordinate PINE-to-PINE communication as will be described below.

While not depicted in FIG. 1 to avoid clutter, the CN 110 may include processing hardware, which may include one or more general-purpose processors (e.g., CPUs) and a non-transitory computer-readable memory storing instructions that the one or more general-purpose processors execute. Additionally or alternatively, the processing hardware can include special-purpose processing units. The processing hardware may be configured to implement the techniques of this disclosure for handling PINE-to-PINE communications.

The base station 104 is equipped with processing hardware that can include one or more general-purpose processors (e.g., CPUs) and a non-transitory computer-readable memory storing instructions that the one or more general-purpose processors execute (not shown). Additionally or alternatively, the processing hardware can include special-purpose processing units.

The UE 102A is equipped with processing hardware 130A that can include one or more general-purpose processors such as CPUs and non-transitory computer-readable memory storing machine-readable instructions executable on the one or more general-purpose processors, and/or special-purpose processing units. The UE 102A also includes a transceiver 132A to communicate with the RAN 105 over a radio interface. Further, the UE 102A includes a memory 134A storing a PEGC module 142A and a PDU controller 140A. With the PEGC module 142 and necessary hardware components (which may be included in or in addition to the processing hardware 130A and/or transceiver 132A), the UE 102A is a PEGC and capable to provide data network (DN) connectivity via a network (e.g., a 5G network) for PINEs (such as the PINE 108A) and/or provide relay functionality for communication between PINEs (such as between the PINEs 108A and 108B, or between the PINEs 108A and 108C). The UE 102B may be configured in a similar manner as the UE 102A. The UE 102B may include a PEGC module 142B, among others. The UE 102C may be configured in a similar manner as the ULE 102A. The UE 102C may include a PEGC module 142C, among others.

The UE 102A is configured to support a PIN 122A. The PIN 122A is a configured and managed group of PINEs (including the PINE 108A) that are able to (1) communicate with each other directly or via PEGCs (including the UEs 108A and 108B), or (2) use a PEGC to communicate with devices or servers that are outside of the PIN via the 5G network. Generally speaking, a PIN includes at least one PEGC and is managed by PINEs with Management Capability (i.e., PEMC(s)). PIN management may be achieved with the support by an application function (AF) if an AF is deployed for PEMG. One will appreciate that the PIN 122A may include more than one PINEs, supported by more than one PEGCs and more than one PEMCs. One will also appreciate that more than PINEs may be connected to the UE 102A. In the depicted example, the PIN 122A is also supported by the UE 102B. A PIN 122B may be configured in a similar manner as the PIN 122A. In the depicted example, the PIN 122B is supported by the UE 102C and includes the PINE 122B.

The PINE 108A is a 3GPP UE or non-3GPP device that can communicate within the PIN 120 (via PINE-to-PINE direct or indirect connection) or outside the PIN 120 via a PEGC and a CN (such as the CN 110). In the depicted example, the PINE 108A is connected to the UE 102A. The PINE 108B may be configured in a similar way as PINE 108A. In the depicted example, the PINE 108B is connected to the UE 102B. The PINE 108C may be configured in a similar way as PINE 108A. In the depicted example, the PINE 108C is connected to the UE 102C.

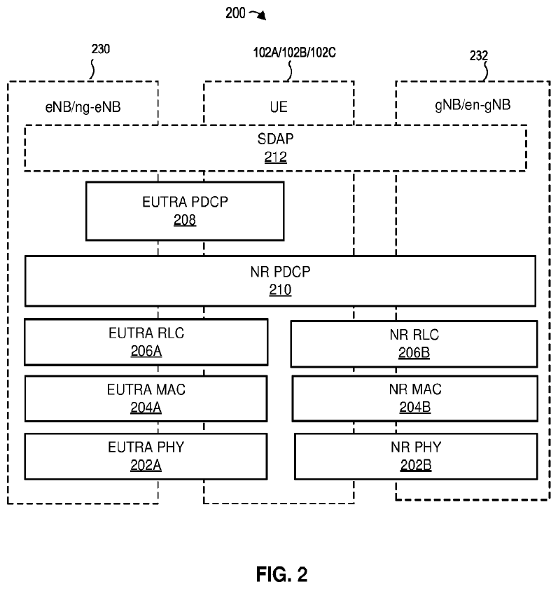

FIG. 2 illustrates, in a simplified manner, an example protocol stack 200 according to which the UE 102A, 102B, or 102C can communicate with an eNB/ng-eNB 230 or a gNB 232 (e.g., one or more of the base stations 104, 106). In the example stack 200, a physical layer (PHY) 202A of EUTRA provides transport channels to the EUTRA MAC sublayer 204A, which in turn provides logical channels to the EUTRA RLC sublayer 206A. The EUTRA RLC sublayer 206A in turn provides RLC channels to a EUTRA PDCP sublayer 208 and, in some cases, to an NR PDCP sublayer 210. Similarly, the NR PHY 202B provides transport channels to the NR MAC sublayer 204B, which in turn provides logical channels to the NR RLC sublayer 206B. The NR RLC sublayer 206B in turn provides data transfer services to the NR PDCP sublayer 210. The NR PDCP sublayer 210 in turn can provide data transfer services to Service Data Adaptation Protocol (SDAP) 212 or a radio resource control (RRC) sublayer (not shown in FIG. 2). The UE 102A, 102B, or 102C, in some implementations, supports both the EUTRA and the NR stack as shown in FIG. 2, to support handover between EUTRA and NR base stations and/or to support DC over EUTRA and NR interfaces. Further, as illustrated in FIG. 2, the UE 102A or 102B can support layering of NR PDCP 210 over EUTRA RLC 206A, and SDAP sublayer 212 over the NR PDCP sublayer 210.

The EUTRA PDCP sublayer 208 and the NR PDCP sublayer 210 receive packets (e.g., from an Internet Protocol (IP) layer, layered directly or indirectly over the PDCP layer 208 or 210) that can be referred to as service data units (SDUs), and output packets (e.g., to the RLC layer 206A or 206B) that can be referred to as protocol data units (PDUs). Except where the difference between SDUs and PDUs is relevant, this disclosure for simplicity refers to both SDUs and PDUs as “packets.”

On a control plane, the EUTRA PDCP sublayer 208 and the NR PDCP sublayer 210 can provide signaling radio bearers (SRBs) or RRC sublayer (not shown in FIG. 2) to exchange RRC messages or non-access-stratum (NAS) messages, for example. On a user plane, the EUTRA PDCP sublayer 208 and the NR PDCP sublayer 210 can provide data radio bearers (DRBs) to support data exchange. Data exchanged on the NR PDCP sublayer 210 can be SDAP PDUs, Internet Protocol (IP) packets, or Ethernet packets.

FIG. 3 is a service-based representation 300 of an example CN architecture, which the system of FIG. 1 can implement. In the representation 300, the overall non-roaming reference architecture of the policy and charging control (PCC) framework for the 5GS includes components illustrated using solid lines, and the other components are illustrated using dashed lines. According to this representation, network functions enable other authorized network functions to access their services. The components that are outside the PCC framework include a Network Slicing Selection Function (NSSF) 302, a Network Repository Function (NRF) 306, a Unified Data Management (UDM) 308, an Edge Application Server Discovery Function (EASDF) 310, a Network Slice Specific Authentication and Authorization Function (NSSAAF) 312, an Authentication Server Function (AUSF) 314, a Service Communication Proxy (SCP) 316, and a Network Slice Admission Control Function (NSACF) 318. The non-PCC architecture further includes the UEs 102A and 102B, the PINEs 108A and 108B, and the (R)AN 105.

The PCC framework in the architecture 300 includes a Unified Data Repository (UDR) 352, a Network Exposure Function (NEF) 354, a network data analytics function (NWDAF) 356, an Application Function (AF) 358, a Policy Control Function (PCF) 360, a Charging Function (CHF) 362, an Access & Mobility Management Function (AMF) 364, a Session Management Function (SMF) 366, and a User Plane Function (UPF) 370.

The AMF 364 is generally configured to manage registration, connection, and mobility of a UE (such as the UE 102A or 102B) and provide transport for session management (SM) messages between the UE 102A or 102B and the SMF 366. In some implementations, the AMF 364 is configured to generate logical interface IDs, as will be described below in detail.

The SMF 366 is generally configured to manage sessions, allocate IP addresses for UEs, and provides downlink (DL) notifications. In some implementations, the SMF 366 also includes following functionalities for PIN service: providing per-QoS flow non-3GPP QoS assistance information to the UE (e.g. PEGC), and supporting IP address allocation to UE and PDR configuration with packet filter set for PIN to UPF for framed routing based on PIN group information from the UDM 308.

The UDM 308 is generally configured to handle user identification, access authorization based on subscription data, and subscription management. In some implementations, the UDM 308 is configured to generate or change logical interface IDs, as will be described below in detail. In some implementations, the UDM 308 supports the functionality of PIN group management handling.

The UDR 352 is generally configured to store subscription-related information, such as subscription data, policy data, structured data for exposure, and application data. In some implementations, the UDR 352 is configured to store PIN communication configuration information, as will be described below in detail.

The UPF 370 is generally configured to handle packet routing and forwarding. In some implementations, the UPF 370 includes a functionality of supporting PDR configuration with a packet filter set for the PIN.

The NEF 354 is generally configured to expose a network's capabilities and services to authorized third-party applications.

The AF 358 in some deployment operates in a trusted domain 311 or outside the trusted domain 311, i.e., in a non-trusted domain. The trusted domain 311 is generally internal to the CN 110 and includes such components as the UDM 308, the UDR 352, the PCF 360, the AMF 364, the SMF 366, and the UPF 370. Generally speaking, an AF operating outside the trusted domain 311 (such as operated by an authorized third-party entity) can access the network functions of the CN 110 only via the NEF 354, whereas an AF operating within the trusted domain 311 can access at least some of the network functions of the CN 110 directly, or may access these functions via the NEF 354 in some deployments. In some deployments, the AF 358 is included in a PIN application server 390.

The UE 102A (PEGC) or the AF 358 may provide QoS flow parameters to the CN 110. The AF 358 that supports PIN service may also influence traffic routing for PDU sessions for PIN traffic. The PIN traffic can be categorized into following types: (1) between two PINEs, which is via 5G core network when the two PINEs connect to different PEGCs; (2) between PINE and PEMC via a PEGC and 5G core network; (3) between PINE and DN via a PEGC and 5G core network; (4) Between PEGC and DN via 5G core network.

The UE 102A (PEGC) or the AF 358, if deployed for a PEMC, may manage a PIN and PINEs using user plane traffic, including PIN traffic or non-PIN traffic, which is “on top” (layered over) of available connection, such as (1) between two PINEs using direct or indirect PINE-to-PINE communication in case of PIN/PINEs managed by the PEMC at a PINE, or (2) between a PINE and a DN, where the AF 358 is located, via PEGC and 5G CN in case of PIN/PINEs managed by AF.

The UE 102A may support PDU session(s) associated with non-PIN service and PDU session(s) associated with PIN service. The UE 102A may include a PIN service indication in the PDU Session Establishment request message to trigger session management for PIN in 5G core network if the request is for PIN services.

One PEGC may serve more than one PINs. In such scenarios, the PEGC may have at least one PDU session for each PIN if the PIN traffic is via PEGC/5GC (5G Core Network). Based on an operator's policies and URSP rules, one PEGC serving more than one PINs may have one PDU session for each PIN or share one PDU session for PIN service. In the scenarios where multiple PDU sessions are with the same DNN and S-NSSAI for different PINs, a PEGC indicates a PIN ID as one of PDU session attributes in a PDU Session Establishment/Modification request.

One PIN may be served by more than one PDU sessions for the PEGC. Based on an operator's policies and URSP rules, one PEGC serving one PIN may use different PDU Sessions for different groups of PINEs.

If a PDU Session Establishment/Modification request is for a PIN service, the SMF may request PIN subscription of the PEGC from the UDM to (1) perform IP address allocation for a PIN or a group of PINEs of a PIN and (2) configure a UPF with PDR including a packet filter set that indicates a destination PIN, e.g., using an External Group Identifier or an IP address group, or a destination group of PINEs within the same PIN. For IP PDU Session Type, the Packet Filter Set may support Packet Filters based on any combination of: (1) a source/destination IP address or IPv6 prefix, (2) a source/destination port number, (3) a protocol ID of the protocol above IP/Next header type, (3) a type of Service (TOS) (IPv4)/Traffic class (IPv6) and Mask, (4) a flow label (IPv6), (5) a security parameter index, (6) a packet filter direction, and/or (7) source/destination PIN IP address or IPv6 prefix.

For PINE-to-PINE indirect communications, the PEGC may base on IP header information to route PIN traffics to a destination PIN (in scenarios where multiple PINs share a PDU session) or a PIN subgroup (in scenarios where multiple PDU sessions support one PIN). Ultimately, the PEGC may forward PIN traffics to destination PINEs (including UEs or non-3GPP devices) based on the IP address information of a destination PINE, e.g., MAC address mapped from a virtual interface ID in an IPv6 header.

For PIN traffics, the PEGC indicates a PIN ID to differentiate PDU sessions with same DNN and S-NSSAI for different PINs.

FIG. 4 is a reference-point based representation 400 of an example 5GS architecture. In FIG. 4, the non-roaming reference architecture of the PCC framework for the 5GS is illustrated as blocks and connections with solid lines, and components and connections outside the PCC framework are illustrated using dashed lines.

The communication system shown FIGS. 1-4 in may include additional, fewer, and/or alternative devices or functionalities, and may be configured to perform additional, fewer, or alternate actions, including functionalities/actions described herein.

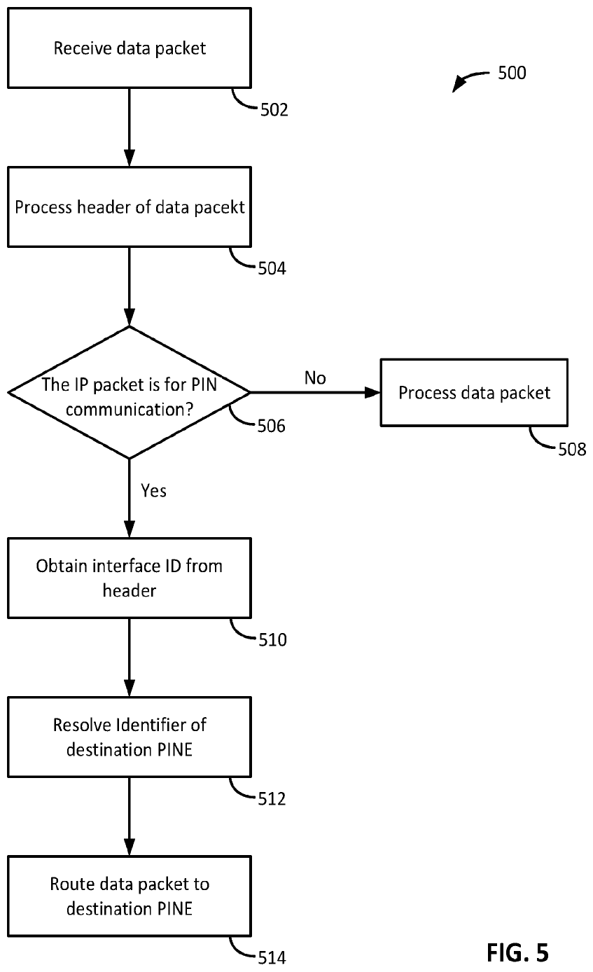

Example techniques for identifying a PIN and/or PINE for PINE-to-PINE communications are discussed with example reference to FIG. 5. These techniques can be used in conjunction with the techniques discussed above or separately from these techniques, depending on the implementation or scenario.

Generally, a CN and a UE can use information indicated in a header of a IP packet for handling PIN traffic routing. The IP packet may be an IPv4 packet or an IPv6 packet. Correspondingly, the header may be an IPv4 header or an IPv6 header. An IP payload (either an IPv4 payload or an IPv6 payload) may encapsulate IP packets to be transmitted by PINEs using IP-based connectivity and non-IP packets to be transmitted by PINEs using non-IP-based connectivity.

To support a PINE-to-PINE communication within a PIN via a CN, several NFs of the CN are configured in the following manner, in an example implementation:
(1) The AF maintains group information associated with a PIN, UEs with PEGC, and PINEs. The AF also enables an application to offer PINE-to-PINE communication among PIN group members.
(2) The CN manages PIN group subscription, PIN service subscription for UEs with PEGC, session management for PIN services, policies for PIN services, and traffic routing of PIN communication.
(3) A UE (PEGC) handles PINE connectivity, and session management for PINEs behind the UE in one or more PINs.

The UEs (PEGCs), the CN, and the AF coordinate with at least one of the following PIN communication configuration information: (1) a PIN ID, (2) UEs with PEGC identified by GPSI or SUPI as PIN group members, and (3) PINE IDs of the associated with PEGC as PIN subgroup members.

For a PIN, PINEs served by a UE (PEGC) can use IP-based connectivity (e.g., Wi-Fi) or non-IP-based connectivity (e.g., Bluetooth). A PINE ID is uniquely identifiable for a PINE by a UE with PEGC connected with the PINE within the associated PIN.

The PIN communication configuration information described above enables PINE-to-PINE communication between an IP-based PINE and a non-IP-based PINE. For example, an IP-based PINE (e.g., a front doorbell connected with a UE with PEGC via Wi-Fi) may send a message to a non-IP-based PINE (e.g., a pair of earbuds connected with the same or a different UE with PEGC via Bluetooth) and/or another IP-based PINE (e.g., a smart home device connected with the same or a different UE (PEGC) via Wi-Fi) using the PIN communication configuration information described above.

In some implementations, the UE (PEGC) stores the PIN communication configuration information locally. The UE (PEGC) uses the PIN communication configuration information in a PIN service layer to route a IP packet to a destination PIN based on a PINE ID in a header of the IP packet. The PIN service layer is between a 3GPP NAS layer and an application layer, for example, a PIN connection manager in an operation system (OS) or a PIN service controller in an application processor.

The UE (PEGC) has routing capabilities to connect the 3GPP network and the PIN to handle PIN communication. To this end, the UE may perform static routing based on a mapping table, stored on the UE, between a destination PINE address and a logical interface ID for the connected PINE. Alternatively, the UE may perform dynamic routing (e.g., using DHCP functionalities from a pool of allocated IP addresses) to manage a routing table (e.g., stored on the UE) between a destination PINE address and a logical interface ID for the connected PINE.

The logical interface ID may be generated by a UE (e.g., the UE with PEGC), an AF, or a Unified Data Management (UDM), as will be described below in detail. The logical interface ID may be generated in various manners. As an example, a UE, an AF, or a UDM may (1) use the PINE's MAC address (e.g., Bluetooth MAC address or Wi-Fi MAC address) which is a 48-bit unique link layer identifier, and (2) add “FFFE” in the middle, to form a 64-bit logical interface ID. As another example, a UE, an AF, or a UDM may (1) use the PINE's hashed MAC address, and (2) add “FFFE” in the middle, to form a 64-bit logical interface ID. In this manner, the interface ID maintains its uniqueness and protects privacy of the PINE. As yet another example, a UE, an AF, or a UDM may use a random number generator to generate a 64-bit logical interface ID. The randomly generated logical interface ID protects privacy of the PINE. The UE, the AF, or the UDM may create a mapping table between the logical interface ID and the MAC addresses of the PINEs to maintain uniqueness of the logical interface IDs and an association between the PINEs' MAC addresses and the logical interface IDs.

FIG. 5 is a flow diagram 500 of an example method in which a UE (PEGC) (e.g., the UE 102A, 102B, or 102C) identifies a destination PINE based on information in an IP packet. For simplicity, the process is described with reference to an IPv6 packet. However, in general, these techniques can also apply to an IPv4 packet, or any other suitable version of the IP protocol.

At block 502, the UE receives an IPv6 packet. The UE may receive the IPv6 packet from a PINE via another UE (PEGC) in the same PIN. For example, the UE 102A receives an IP packet from the PINE 108B via the UE 102B. Alternatively, UE may receive the IP packet from a PINE via another UE (PEGC) in a different PIN. For example, the UE 102A receives a IP packet from the PINE 108C via the UE 102C. In both cases, a CN may coordinate the PINE-to-PINE communication, as will be described below in detail.

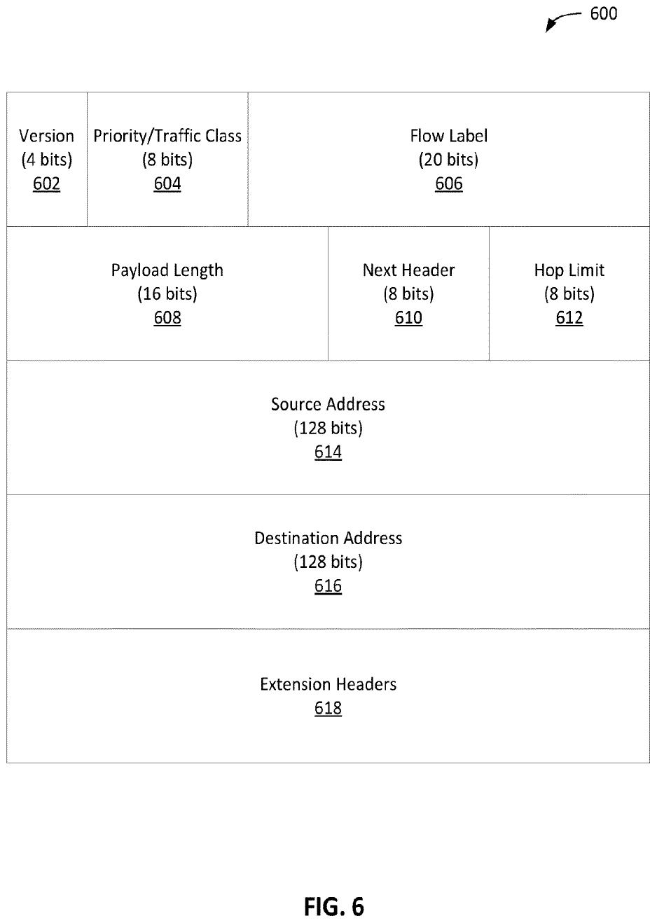

At block 504, the UE processes an IPv6 header of the received IP packet. The IPv6 header includes information for a destination device. The IPv6 header will be described in more detail below with reference with FIG. 6. At block 506, based on the information for the destination device obtained by processing the IPv6 header, the UE determines whether the IPv6 packet is for (a) the UE or (b) a PINE in a PIN for which the UE is a group member. If the IPv6 packet is for the UE, at block 508, the UE processes the packet similar to other IP packets directed to the UE.

If the IP packet is for a PINE connected to the UE, at block 510, the UE obtains a logical interface ID from the processed IPv6 header. At block 512, the UE resolves an identifier of a destination PINE. In some implementations, the identifier is a MAC address of the destination PINE. Based on how the interface ID was generated, as described above, the UE may resolve the MAC address (1) directly from the interface (e.g., by removing the “FFFE” in the middle of the logical interface ID), (2) based on a hash table (e.g., after removing the “FFFE” in the middle of the logical interface ID), or (3) based on a mapping table stored on the UE. At block 514, based on the MAC address, the UE routes the IP packet to the destination PINE.

FIG. 6 illustrates components of an IPv6 header 600. Several example techniques for using an IPv6 header to identify a destination PIN and a destination PINE will be described below. Generally similar principles also can apply to an IPv4 header, or any other suitable version of the IP protocol.

In some implementations, the destination PINE can be identified based on a destination address field 616 in the IPv6 header 600. In such implementations, the PINE ID is a logical interface ID associated with a PINE (either an IP-based PINE or a non-IP-based IP). An IPv6 address (128 bits) of the PINE is configured using an IPv6 prefix (first 64 bits) and the logical interface ID (last 64 bits) of the PINE. The source address filed 614 indicates an IPv6 address of a source PINE ID of a source PINE (e.g., a PINE that transmits an IP packet). The destination address field 616 indicates an IPv6 address of a destination PINE ID of the destination PINE (e.g., a PINE that receives the IP packet). The next header field 610 indicates an assigned value pointing to a specific extension header in the extension header field 618. The specific extension header indicates a PIN ID of the destination PIN.

In some implementations, the destination PINE can be identified based on a specific extension header in the IPv6 header 600. In such implementations, the source address field 614 indicates an IPv6 address of a source UE (PEGC) (e.g., a UE that receives a IP packet from a source PINE and transmits the IP packet to a destination UE). The destination address field 616 indicates an IPv6 address of a destination UE (PEGC) (e.g., a UE that receives the IP packet from the source UE and transmits the IP packet to the destination PINE). The next header field 610 indicates an assigned value pointing to a specific extension header in the extension header field 618. The specific extension header indicates a PIN ID of the destination PIN, a source PINE ID of the source PINE, and a destination PINE ID of the destination PINE. In these implementations, the PIN communication configuration information additionally includes an allocated value for a specific extension header used for PIN services, which is unique within its Public Land Mobile Network (PLMN) or globally.

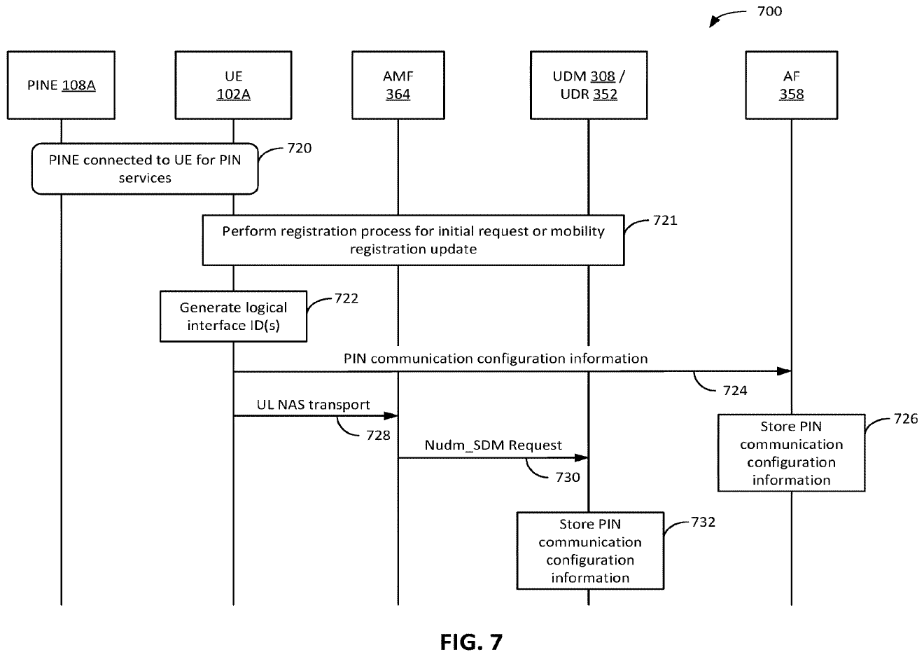

Next, example techniques for coordinating PIN configuration information are discussed with example reference to FIGS. 7-10. These techniques can be used in conjunction with the techniques discussed above or separately from these techniques, depending on the implementation or scenario.

A CN (e.g., a UDM of the CN) may store PIN communication configuration information. The PIN communication configuration information may be generated and coordinated in various manners, as will be discussed below.

In some implementations, a UE (PEGC) generates a logical interface ID as a PINE ID. The PINE ID can uniquely identify an interface on the UE using a PINE's physical MAC address, a PINE's hashed MAC address, or a random number associated with a PINE, as described above.

For an IP-based PINE, a UE (PEGC) may obtain a logical interface ID of the PINE in various manners. As an example, the PINE as an IPv6 host generates a logical interface ID. The PINE then provides the interface ID to the UE using a Neighbor Discovery protocol. As another example, the UE (PEGC) generates a unique logical interface ID for the PINE within a PIN subgroup.

For a non-IP-based PINE, a UE (PEGC) may obtain a logical interface ID of the PINE in various manners. As an example, the UE (PEGC) generates a unique logical interface ID for the PINE within a PIN subgroup.

For a PIN subgroup including both an IP-based PINE and a non-IP-based PINE, the UE (PEGC) may generate a unique logical interface ID for the PINEs within the PIN subgroup.

The UE (PEGC) maintains a logical interface ID and a PINE ID for each PINE connected to the UE. The UE uses the IDs for mapping the IDs and the PINEs locally. The UE may coordinate the PIN communication configuration information in various manners as will be described below.

FIG. 7 is a messaging diagram 700 for an example process coordinating PIN communication configuration information generated by a UE (i.e., UE-based PIN communication configuration information). The PINE in FIG. 7 may be the PINE 108A, 108B, or 108C. For convenience, the description refers to the PINE 108A as an example PINE. The UE in FIG. 7 may be the UE 102A, 102B, or 102C. For convenience, the description below refers to the UE 102A as an example UE. Although the process below is described with one PINE connected to the UE 102A, one will appreciate that more than one PINEs may be connected to the UE 102A, in which case more than one PINE IDs and/or logical interface IDs will be generated and coordinated.

Initially, the PINE 108A is connected 720 to the UE (PEGC) 102A for PIN services from the PIN 122A. The UE 102A, the AMF 364, and the UDM 308/UDR 352 perform 721 a registration process. The registration process may be for an initial request or for a mobility registration update.

The UE 102A generates 722 a logical interface ID as a PINE ID for the PINE 108A. The UE 102A transmits 724 user plane traffic with PIN communication configuration information for the PIN 122A. The PIN communication configuration information includes (1) a PIN ID of the PIN 122A, (2) a UE ID of the UE 102A (as a PIN group member), where the UE ID is represented by GPSI, and (3) a list of logical interface IDs, i.e., the PINE ID of PINE 108A (as PIN subgroup members). The AF 358 stores 726 the communication configuration information for the PIN 122A.

The UE 102A transmits 728 a UL NAS transport message to the AMF 364364. The UL NAS transport message includes a NAS container for the PINE(s) 108A. The AMF 364 transmits 730 an Nudm_SDM request message to the UDM 308/UDR 352. The Nudm_SDM request message includes PIN communication configuration information, including at least of the following: (1) a PIN ID of the PIN 122A, (2) a list of UE IDs of the UEs (PEGCs) (including the UE 102A) (as PIN group members), where the UE IDs are represented by GPSI, and (3) a list of logical interface IDs, i.e., the PINE IDs of PINEs in the PIN for each UE in the IE list (including the ID for PINE 108A in the list for UE 102A) (as PIN subgroup members). The UDM 308/UDR 352 stores 732 the PIN communication configuration information for the PIN 122A.

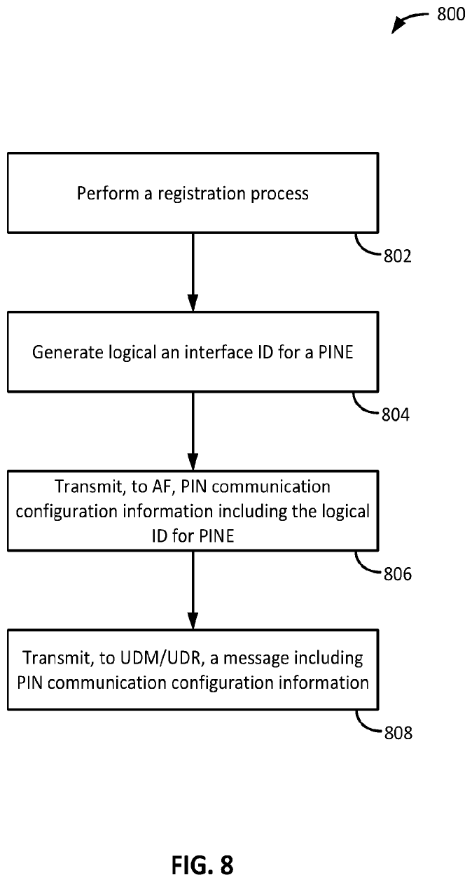

FIG. 8 is a flow diagram of an example method 800, which can be implemented in the UE 102A, for coordinating UE-based PIN communication configuration information.

Initially, the UE 102A is connected to the PINE(s) 108A to provide PIN services to the PINE(s) 108A. At block 802, the UE 102A performs a registration process with the AMF 364 and the UDM 308/UDR 352 as described with respect to step 721. At block 804, the UE 102A generates a logical interface ID for the PINE 108A as described with respect to step 722. At block 806, the UE 102A transmits PIN communication configuration information, including the logical interface ID for the PINE 108A, to the AF 358 for the AF 358 to store thereon, as described with respect to steps 724 and 726. At block 808, the UE 102A transmits a request message via the AMF 364 to the UDM 308/UDR 352, wherein the request message includes PIN communication configuration information, including the logical interface ID for the PINE 108A, for the UDM 308/UDR 352 to store thereon, as described with respect to steps 728-732. The PIN communication configuration information of blocks 806 and 808 may include different information, as described with respect to steps 724 and 730, respectively.

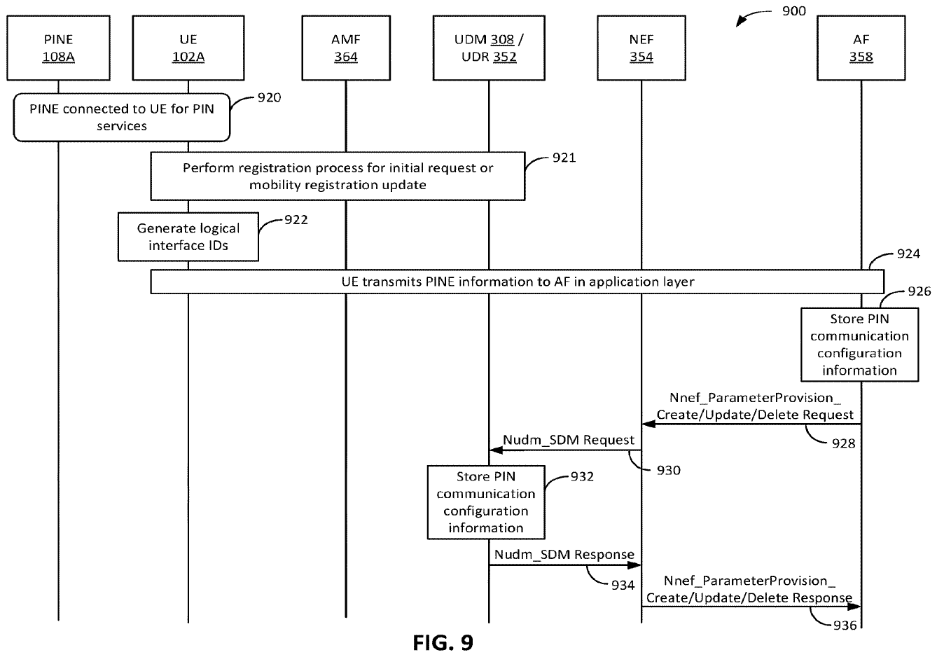

FIG. 9 is a messaging diagram of another example process 900 for coordinating UE-based PIN communication configuration information.

Events 920-926 can be implemented similar to events 720-726, respectively. The AF 358 transmits 928 to the NEF 354 an Nnef_ParameterProvision_Create request message, an Nnef_ParameterProvision_Update request message, or an Nnef_ParameterProvision_Delete request message to provision PIN service parameters (e.g., PIN communication configuration information). The transmitted request message includes PIN communication configuration information such as for example: (1) identifiers of destination IEs (including the UE 102A), where the identifiers may be external identifiers or GPSI, (2) a PIN ID of the PIN 122A, (3) a list of UE IDs of the UEs with PEGC (including the UE 102A) (as PIN group members), where the UE IDs are represented by GPSI, and (4) a list of logical interface IDs, i.e., the PINE IDs of PINEs in the PIN for each UE in the UE list (including the ID for PINE 108A in the list for UE 102A) (as PIN subgroup members).

The NEF 354 transmits 930 a Numd_SDM request message to the UDM 308/UDR 352. The message includes the PIN communication configuration information in the Nnef_ParameterProvision_Create request message, the Nnef_ParameterProvision_Update request message, or the Nnef_ParameterProvision_Delete request message. The UDM 308/UDR 352 stores 932 the PIN communication configuration information.

The UDM 308/UDR 352 transmits 934 a Nudm_SDM response message to the NE F 354. The NEF 354 transmits 936 an Nnef_ParameterProvision_Create response message, an Nnef_ParameterProvision_Update response message, or an Nnef_ParameterProvision_Delete response message to the A F 358, corresponding to the message received during the event 928. By transmitting 934, 936 the two response messages, the UDM confirms the receipt of the PIN service parameters (e.g., the PIN communication configuration information) with the AF 358.

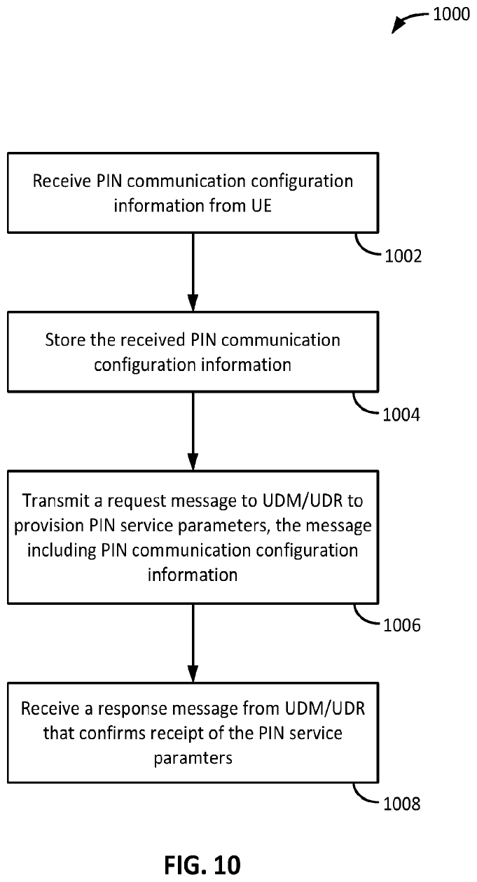

FIG. 10 is a flow diagram of an example method 1000, which can be implemented by the AF 358, for coordinating UE-based PIN communication configuration information.

The AF 358 receives 1002 PIN configuration information from the UE 102A, as described with respect to the event 924. The AF 358 stores 1004 the received PIN communication configuration information, as discussed with reference to the event 926. THe AF 358 transmits 1006 a request message to the UDM 308/UDR 352 to provision PIN service parameters, where the request message includes the PIN communication configuration information for the URM 308/UDR 352 to store. In the implementations where the AF 358 is outside the trusted domain 311, the AF 358 transmits the request message via the NEF 354, as described with reference to the events 928 and 930. In the implementations where the AF 358 is in the trusted domain 311, the AF 358 transmits the request message (e.g., a Nudm_SDM request message) to the URM 308/UDR 352 directly. The PIN communication configuration information of the events 1002 and 1006 may include different information, as described with reference to the events 924 and 928, respectively. The AF 358 receives 1008 a response message from the URM 308/UDR 352 (1) directly or (2) via the NEF 354 as described with respect to steps 934 and 936. The response message confirms that the URM 308/UDR 352 receives the PIN service parameters.

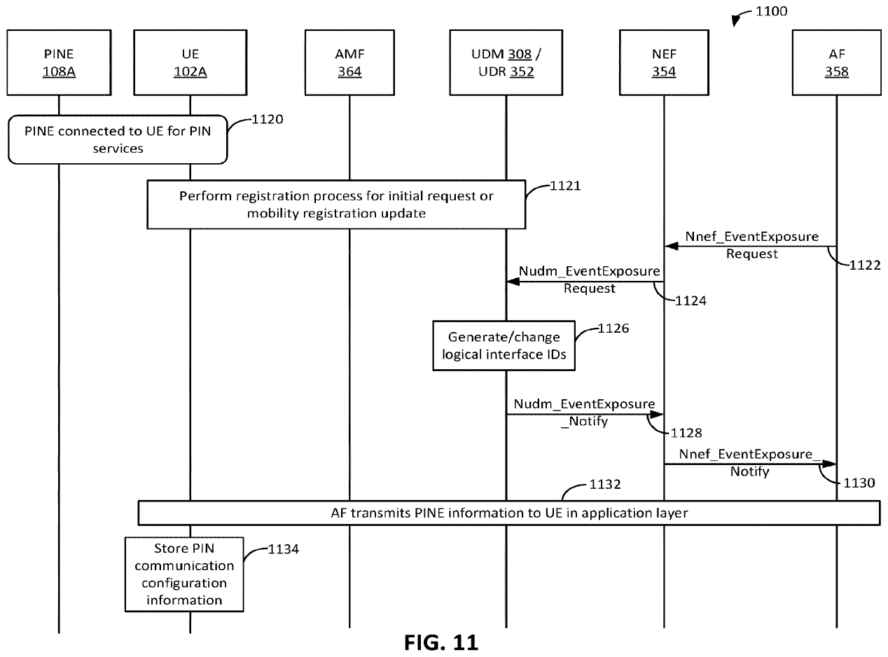

Next, example techniques for coordinating PIN configuration information are discussed with example reference to FIGS. 11-16. These techniques can be used in conjunction with the techniques discussed above or separately from these techniques, depending on the implementation or scenario.

In some implementations, a UDM of a CN generates a logical interface ID as a PINE ID. The PINE ID can uniquely identify an interface on the UE using a PINE's physical MAC address, a PINE's hashed MAC address, or a random number associated with a PINE, as described above.

The UDM stores subscription information of PIN services for a UE with PEGC. The subscription information includes a maximum allowed number of PINEs in a PIN. The UDM generates logical interface IDs based on the PIN services subscription information of the UE with PEGC, where the number of the generated logical interface IDs is equal to the stored maximum allowed number of PINEs.

The UE with PEGC maintains logical interface IDs and PINE IDs and is capable of mapping between the logical interface IDs and the PINE IDs locally. The UDM coordinates with the UE with PEGC and AF in the processes described below. In these processes, an event ID is introduced for network capability exposure of information of the PIN via a Nnef_EventExposure request.

FIG. 11 is a messaging diagram of an example process 1100 for coordinating PIN communication configuration information generated by a UDM (i.e., UDM-based PIN communication configuration information).

Events 1120 and 1121 are performed in a similar manner as events 720 and 721, respectively. The AF 358 transmits 1122 a Nnef_EventExposure request message to the NEF 354. The message includes an indication of a destination UE, an event ID indicating PIN services information, and at least one of (1) a PIN service indication and (2) a PIN ID. The NEF 354 transmits 1124 a Nudm_EventExposure request message to the UDM 308/UDR 352. The Nudm_EventExposure request message includes the indication of the destination UE, the event ID indicating PIN services information, and the at least one of (1) the PIN service indication and (2) the PIN ID. By transmitting these request messages, the UDM 308/UDR 352 is able to receive notifications of PIN communication configuration information changes.

The UDM 308/UDR 352 generates 1126 logical interface IDs as PINE IDs. The UDM 308/UDR 352 transmits 1128 a Nudm_EventExposure_Notify message to the NEF 354. The message includes PIN communication configuration information, which can include (1) a PIN ID of the PIN, (2) a list of UE IDs of the UEs with PEGC (including the UE 102A) (as PIN group members), where the UE IDs are represented by GPSI, and (3) a list of logical interface IDs, i.e., the PINE IDs of PINEs in the PIN for each UE in the UE list (as PIN subgroup members). The NEF 610 transmits 1130 a Nnef_EventExposure_Notify message to the NEF 354. The message includes the PIN communication configuration information. By transmitting these two messages, the UDM 308/UDR 352 notifies the AF 358 of the PIN communication configuration information.

The AF 358 transmits 1132 user plane traffic, in an application layer, to the UE 102A including PIN communication configuration information, which can include (1) a PIN ID of the PIN, (2) a UE ID of the UE 102A with PEGC (as a PIN group member), where the UE ID is represented by GPSI, and (3) a list of logical interface IDs, i.e., the PINE IDs of PINEs in the PIN connected to the UE 604 (as PIN subgroup members). At step 1134, the UE 102A stores the PIN communication configuration information. The UE 102A maintains a mapping table between the interface IDs (i.e., PINE IDs) and MAC addresses of the PINEs 108A using the PIN communication configuration information.

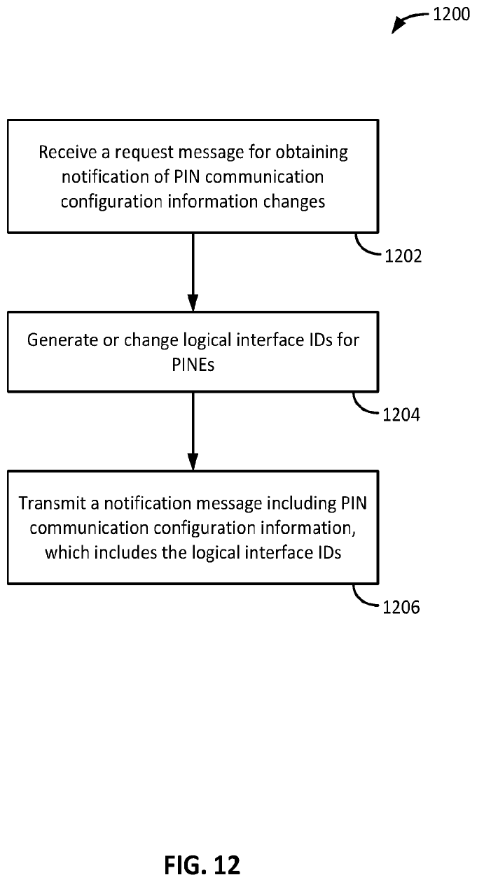

FIG. 12 is a flow diagram of an example method 1220, which can be implemented by the UDM 308/UDR 352, for coordinating UDM-based PIN communication configuration information.

At block 1202, the UDM 308/UDR 352 receives a request message from the AF 358. The UDM 308/UDR 352 may receive the request message either directly from the AF 358 or via the NEF 354 (as described with respect to steps 1122 and 1124), depending whether the AF 358 is within the trusted domain 311. Upon receiving the request message, the UDM 308/UDR 352 will provide notifications to the AF 358 when there is any change to PIN communication configuration information, including but not limited generating or changing logical interface IDs for PINEs. At block 1204, the UDM 308/UDR 352 generates or changes logical interface IDs for PINEs, as described with respect to step 1126. At block 1206, the UDM 308/UDR 352 transmits to the AF 358 directly or indirectly a notification message including PIN communication configuration information, wherein the PIN communication configuration information includes the generated or changed logical interface IDs, as described with respect to steps 1128 and 1130.

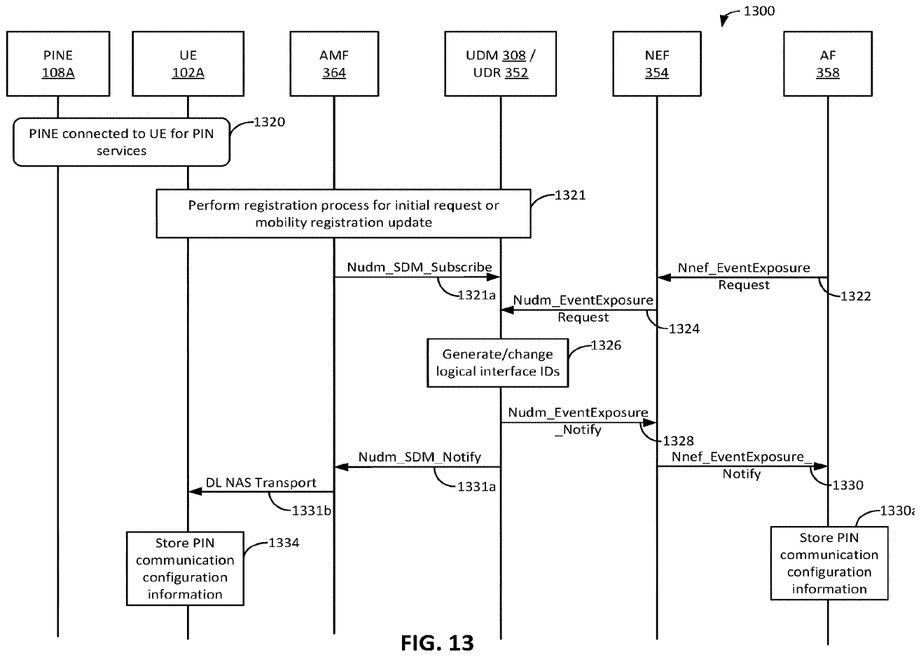

FIG. 13 is a messaging diagram of another example process 1300 for coordinating UDM-based PIN communication configuration information.

Events 1320 and 1321 are similar manner to the events 720 and 721, respectively. The AMF 364 transmits 1321a a Nudm_SDM_Subscribe request message to the UDM 308/UDR 352 such that the AMF 364 will receive notification of PIN changes. The Nudm_SDM_Subscribe request message includes at least one of a PIN service indication and a PIN ID of the PIN.

Events 1322-1330 are similar to the events 1122-1130, respectively. The AF 358 stores 1330a the PIN communication configuration information from the Nnef_EventExposure_Notify message received during the event 1330.

The UDM 308/UDR 352 transmits 1331a a Nudm_SDM Notify message to the AMF 364. The message includes PIN communication configuration information, which includes (1) a PIN ID of the PIN, (2) a UE ID of the UE 604 with PEGC (as a PIN group member), where the UE ID is represented by GPSI, and (3) a list of logical interface IDs, i.e., the PINE IDs of PINEs in the PIN connected to the UE 604 (as PIN subgroup members). The AMF 364 transmits 1331b a DL NAS transport message. The message includes a NAS container for the PIN communication configuration information. Event 1334 can be to he event 1134.

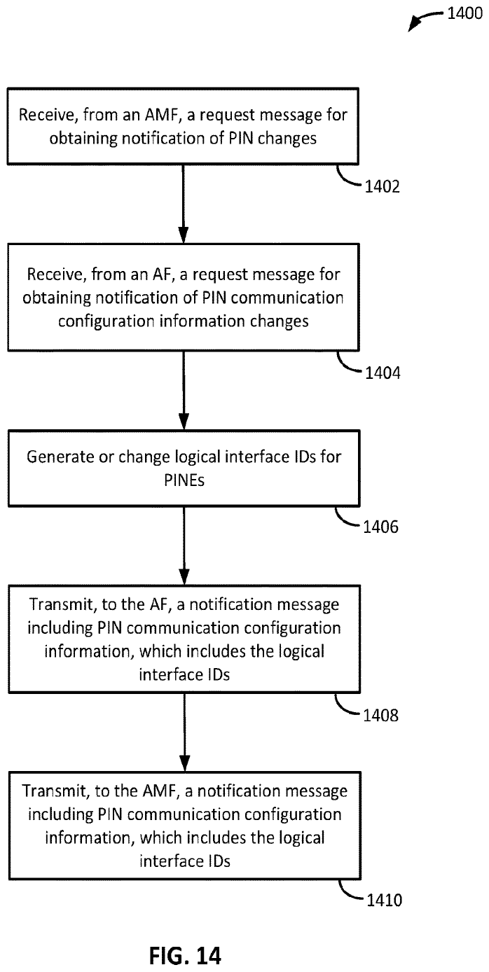

FIG. 14 is a flow diagram of an example method 140s, implemented by the UDM 308/UDR 352, for coordinating UDM-based PIN communication configuration information.

At block 1402, the UDM 308/UDR 352 receives a request message from the AMF 364, as described with respect step 1321a. Upon receiving the request message, the UDM 308/UDR 352 will provide notifications to the AF 358 when there is any change to the PIN 122A, including but not limited generating or changing logical interface IDs for PINEs.

At block 1404, the UDM 308/UDR 352 receives a request message from the AF 358. The UDM 308/UDR 352 may receive the request message either directly from the AF 358 or via the NEF 354 (as described with respect to steps 1322 and 1324), depending whether the AF 358 is within the trusted domain 311. Upon receiving the request message, the UDM 308/UDR 352 will provide notifications to the AF 358 when there is any change to PIN communication configuration information, including but not limited generating or changing logical interface IDs for PINEs.

At block 1406, the UDM 308/UDR 352 generates or changes logical interface IDs for PINEs, as described with respect to step 1326.

At block 1408, the UDM 308/UDR 352 transmits to the AF 358 directly or indirectly a notification message including PIN communication configuration information for the AF 358 to store thereon, wherein the PIN communication configuration information includes the generated or changed logical interface IDs, as described with respect to steps 1328 and 1330.

At block 1410, the UDM 308/UDR 352 transmits to the AMF 364 a notification message including PIN communication configuration information, wherein the PIN communication configuration information includes the generated or changed logical interface IDs, as described with respect to step 1331a.

The PIN communication configuration information of blocks 1408 and 1410 may include different information, as described with respect to steps 1328 and 1331a, respectively.

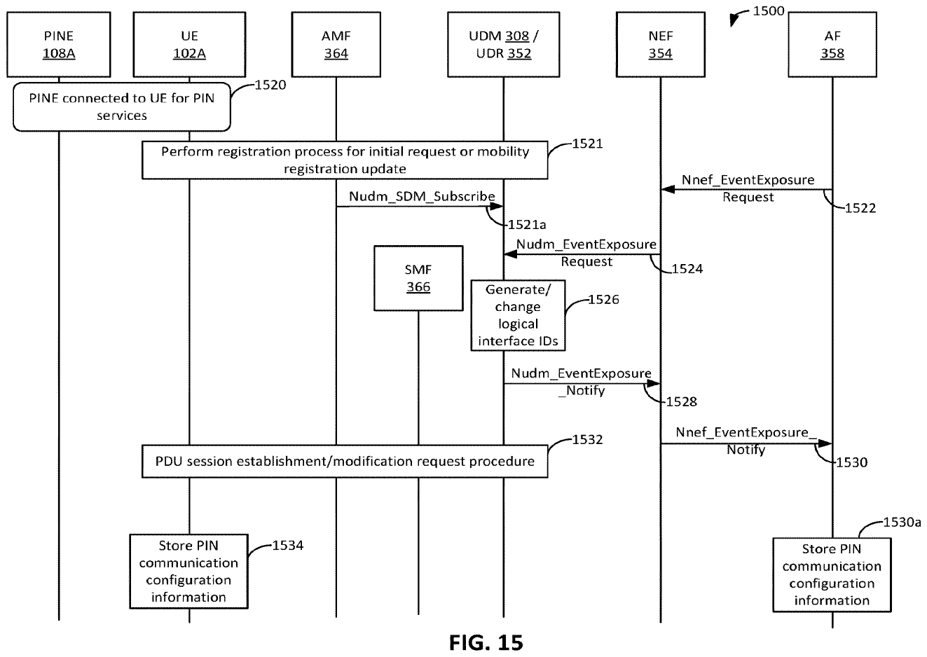

FIG. 15 is a messaging diagram of yet another example process 1400 for coordinating UDM-based PIN communication configuration information.

Events 1520-1530a are similar to the events 1320-1330a, respectively. The UE 102A, the AMF 364, the SMF 364, and the UDM 308/UDR 352 perform 1532 a PDU session establishment or modification request procedure. More specifically, the UDM 308/UDR 352 transmits PIN service subscription information to the SMF 366. The PIN service subscription information includes PIN communication configuration information, which includes at least one of: (1) a PIN ID of the PIN, (2) a list of UE IDs of the UEs with PEGC (including the UE 102A) (as PIN group members), where the UE IDs are represented by GPSI, and (3) a list of logical interface IDs, i.e., the PINE IDs of PINEs in the PIN for each UE in the UE list (as PIN subgroup members). The SMF 366 transmits to the UE 102A (e.g., via the AMF 364) a PDU Session Establishment/Modification Accept message, which includes the PIN communication configuration information. Event 1534 is similar to the event 1334.

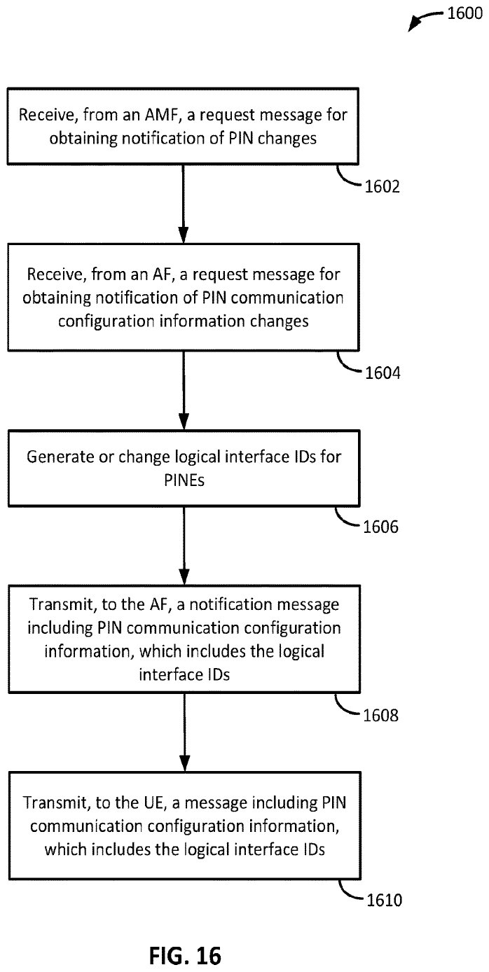

FIG. 16 is a flow diagram of an example method 1600, implemented by the UDM 308/UDR 352, for coordinating UDM-based PIN communication configuration information.

At block 1602, the UDM 308/UDR 352 receives a request message from the AMF 364, as described with reference to the event 1521a. Upon receiving the request message, the UDM 308/UDR 352 provides notifications to the AF 358 when there is any change to the PIN 122A, including but not limited generating or changing logical interface IDs for PINEs.

At block 1604, the UDM 308/UDR 352 receives a request message from the AF 358. The UDM 308/UDR 352 may receive the request message either directly from the AF 358 or via the NEF 354 (as described with respect to steps 1522 and 1524), depending whether the AF 358 is within the trusted domain 311. Upon receiving the request message, the UDM 308/UDR 352 will provide notifications to the AF 358 when there is any change to PIN communication configuration information, including but not limited generating or changing logical interface IDs for PINEs.

At block 1606, the UDM 308/UDR 352 generates or changes logical interface IDs for PINEs, as described with respect to step 1526.

At block 1608, the UDM 308/UDR 352 transmits to the AF 358 directly or indirectly a notification message including PIN communication configuration information for the AF 358 to store thereon, wherein the PIN communication configuration information includes the generated or changed logical interface IDs, as described with respect to steps 1528 and 1530.

At block 1610, the UDM 308/UDR 352 transmits to the UE 102A a message including PIN communication configuration information, wherein the PIN communication configuration information includes the generated or changed logical interface IDs, as described with respect to step 1532.

The PIN communication configuration information of blocks 1608 and 1610 may include different information, as described with respect to steps 1528 and 1532, respectively.

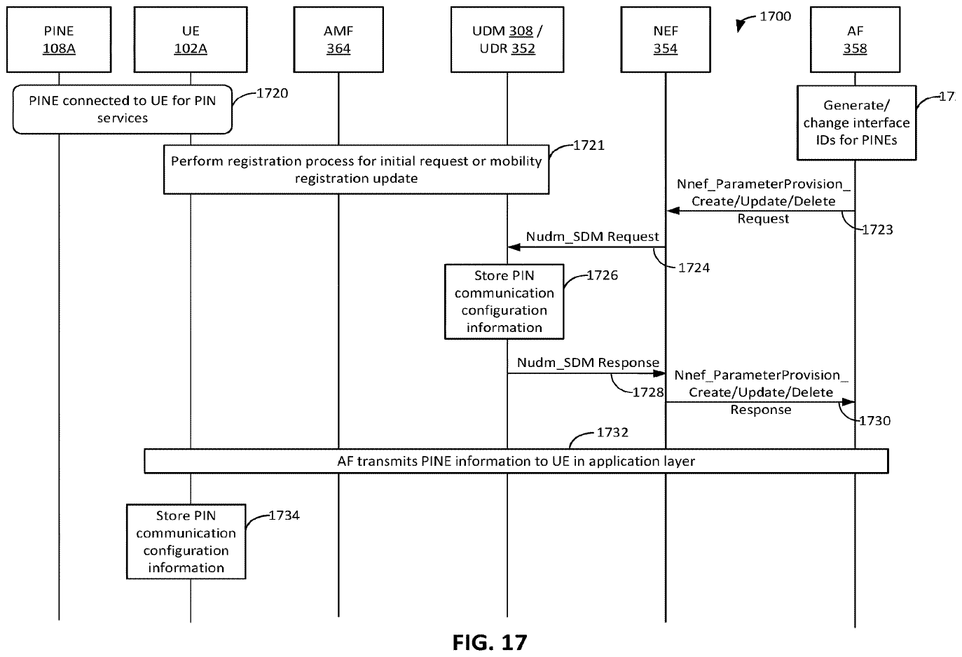

Next, example techniques for coordinating PIN configuration information are discussed with example reference to FIGS. 17-19. These techniques can be used in conjunction with the techniques discussed above or separately from these techniques, depending on the implementation or scenario.

In some implementations, an AF of a CN generates a logical interface ID as a PINE ID. The PINE ID can uniquely identify an interface on the UE using a PINE's physical MAC address, a PINE's hashed MAC address, or a random number associated with a PINE, as described above.

The UE with PEGC maintains logical interface IDs and PINE IDs and is capable of mapping between the logical interface IDs and the PINE IDs locally. The AF coordinates with the UE with PEGC and a UDM in the processes described below.

FIG. 17 is a messaging diagram of an example process 1700 for coordinating PIN communication configuration information generated by an AF (i.e., AF-based PIN communication configuration information).

Events 1720 and 1721 are similar to the events 720 and 721, respectively. The AF 358 generates 1722 or changes interface TD(s) as PINE ID(s) for PINE(s). The AF 358 transmits 1723 to the NEF 354 an Nnef_ParameterProvision_Create request message, an Nnef_ParameterProvision_Update request message, or an Nnef_ParameterProvision_Delete request message to provision PIN service parameters (e.g., PIN communication configuration information). The transmitted request message includes PIN communication configuration information: (1) an identifier of a destination UE (e.g., the UE 102A) where the identifier may be an external identifier or GPSI, (2) a PIN ID of the PIN 122A, (3) a list of UE IDs of the UEs (PEGCs) (including the UE 102A) (as PIN group members), where the UE IDs are represented by GPSI, and (4) a list of logical interface IDs, i.e., the PINE IDs of PINEs (at least some of which are generated by the AF 358) in the PIN for each UE in the UE list (including the PINE ID for the PINE 108A in the UE list for the UE 102A) (as PIN subgroup members).

The NEF 354 transmits 1724 a Numd_SDM request message to the UDM 308/UDR 352. The message includes the PIN communication configuration information in the Nnef_ParameterProvision_Create request message, the Nnef_ParameterProvision_Update request message, or the Nnef_ParameterProvision_Delete request message The UDM 308/UDR 352 stores 1726 the PIN communication configuration information.

The UDM 308/UDR 352 transmits 1728 a Nudm_SDM response message to the NEF 354. The NEF 354 transmits 1728 an Nnef_ParameterProvision_Create response message, an Nnef_ParameterProvision_Update response message, or an Nnef_ParameterProvision_Delete response message to the AF 358, corresponding to the message received during the event 1723. By transmitting 1728, 1730 the two response messages at steps, the UDM 308/UDR 352 confirms the receipt of the PIN service parameters (e.g., the PIN communication configuration information) with the AF 358. Events 1732 and 1734 are similar manner to the events 1132 and 1134, respectively.

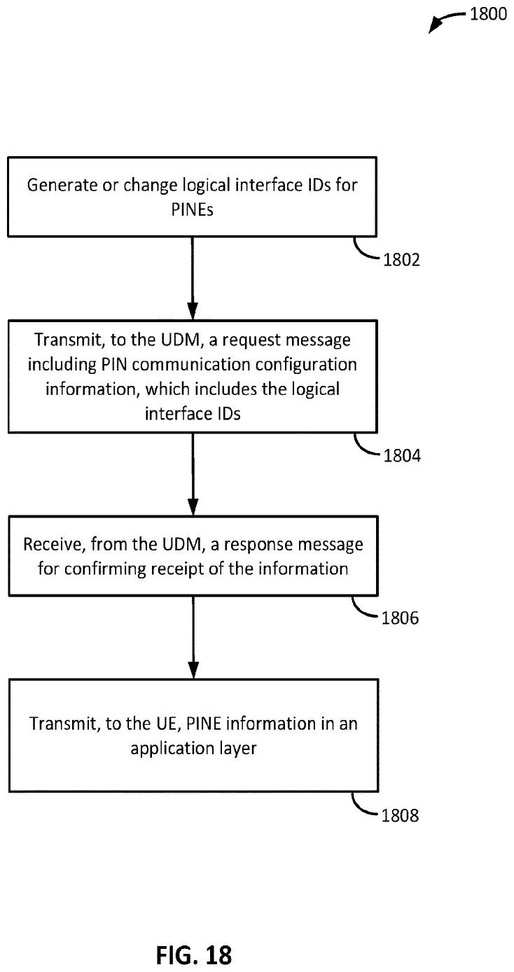

FIG. 18 is a flow diagram of an example method 1800, implemented by the AF 358, for coordinating AF-based PIN communication configuration information.

At block 1802, the AF 358 generates or changes logical interface IDs for PINEs as described with respect to step 1722. At block 1804, the AF 358 transmits to the UDM 308/UDR 352, either directly or indirectly via the NEF 354, a request message including PIN communication configuration information for the UDM 308/UDR 352 to store, which includes the generated or changed logical interface IDs, as described with respect to steps 1723-1726. At block 1806, the AF 358 receives from the UDM 308/UDR 352, either directly or indirectly via the NEF 354, a response message by which the UDM 308/UDR 352 confirms receipt of the PIN communication configuration information, as described with respect to steps 1728 and 1730. At block 1808, the AF 358 transmits to the UE 102A PIN communication configuration information for the UE 102A to store thereon, wherein the PIN communication configuration information includes information of PINEs such as the generated or changed logical interface IDs, as described with respect to steps 1732 and 1734.

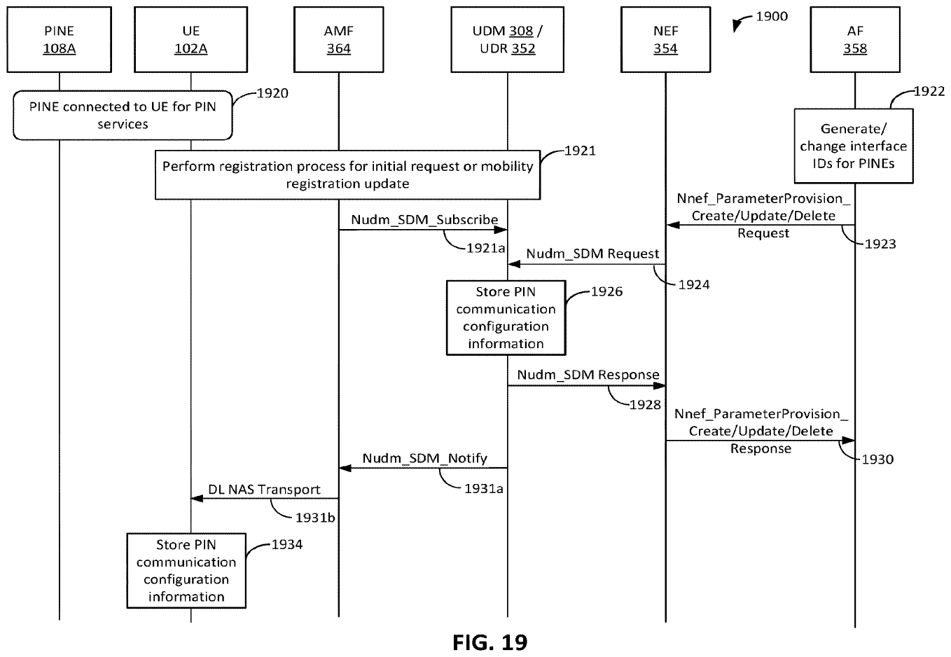

FIG. 19 is a messaging diagram 1900 of another process for coordinating AF-based PIN communication configuration information.

Steps 1920-1921a are performed in a similar manner as steps 1320-1321a, respectively. Steps 1922-1930 are performed in a similar manner as steps 1722-1730, respectively. Steps 1931a-1934 are performed in a similar manner as steps 1331a-1334.

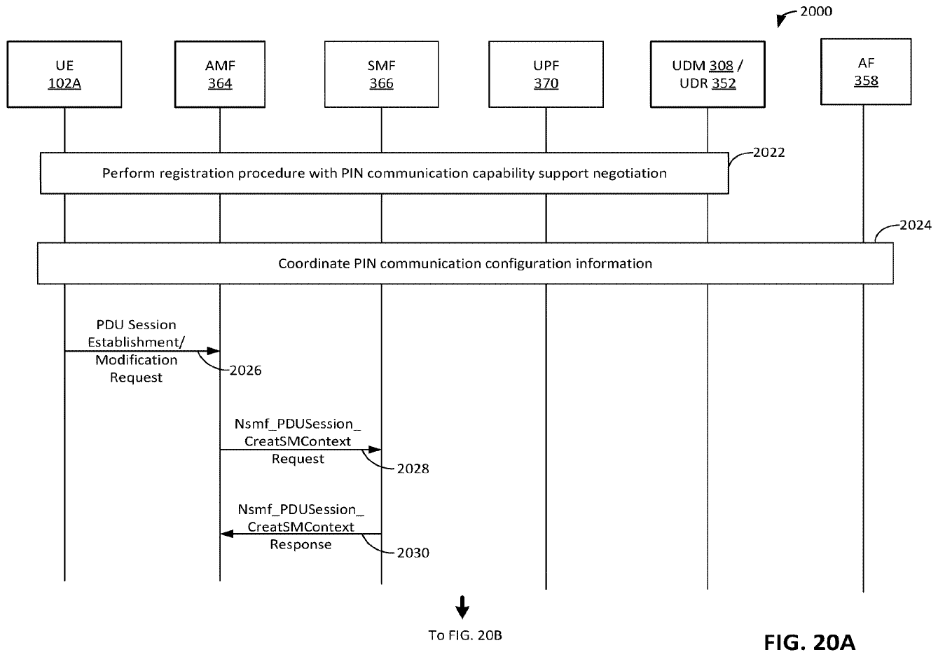

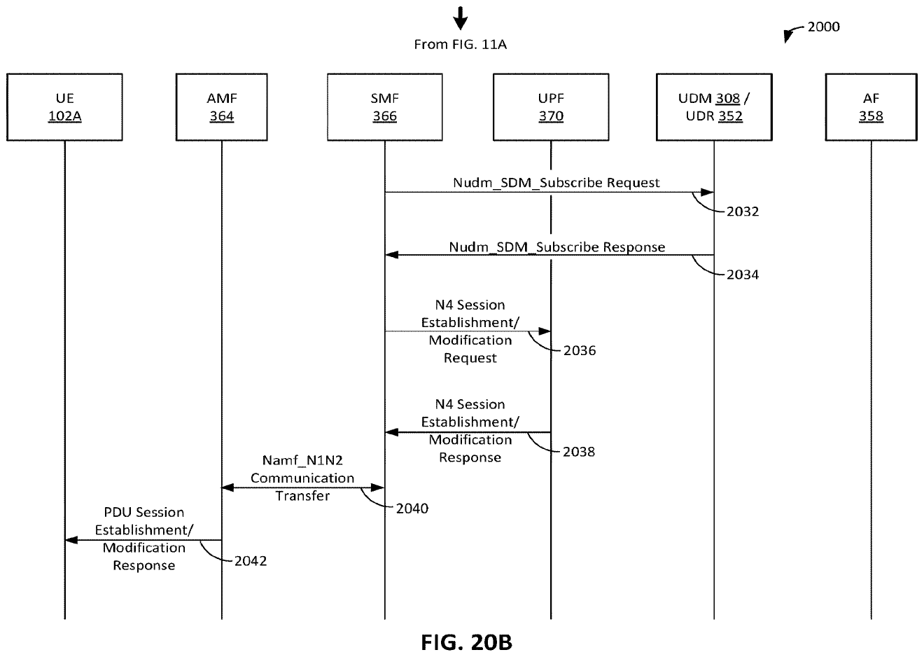

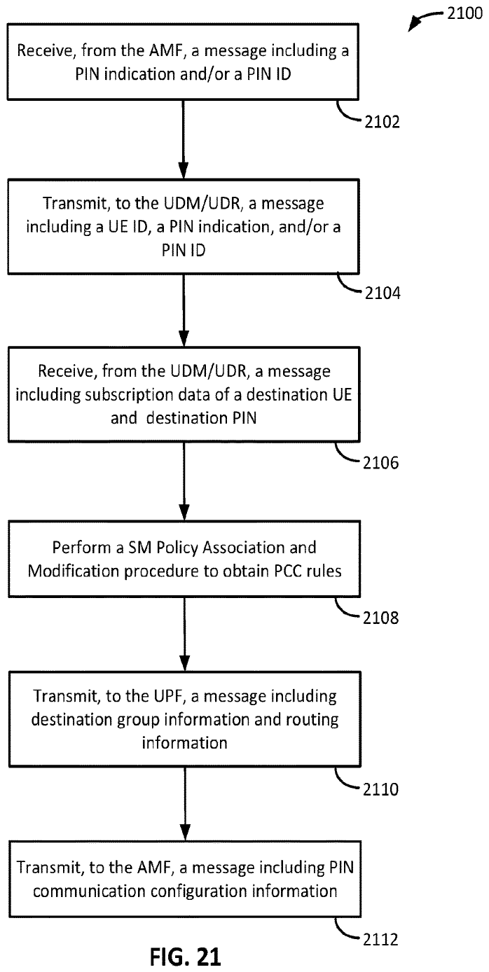

Next, example techniques for coordinating PIN communication using framed routing are discussed with example reference to FIGS. 20A-21. These techniques can be used in conjunction with the techniques discussed above or separately from these techniques, depending on the implementation or scenario.

In the PIN configuration information coordination processes described above, the UDM can provide PIN communication configuration information to the SMF for configuring routing rules over an N4 interface for handling the PIN communication.

In a PDU Session Establishment procedure, a CN and a UE with PEGC in a PIN can handle PIN communication using the following principles: (1) A UDM of the CN provides PIN communication configuration information from to an SMF. (2) The SMF configures a UPF via an N4 session request message including packet detection rule(s) (PDR) and forwarding action rule(s) (FAR) for routing detected PIN traffic based on PIN communication configuration information from the UDM. The PDR contains destination IPv6 prefixes associated with a destination PIN group or subgroup, and a destination PINE using an interface ID of an IPv6 address. The FAR for routing detected PIN traffic to the destination UE with PEGC that serves the PIN group in the PIN, and the N4 session includes routing information for the PIN groups. As an example, the routing information can include a first IPv6 prefix or a first set of IPv6 prefixes allocated to the UE with PEGC for non-PIN services and a second IPv6 prefix or a second set of IPv6 prefixes allocated to a destination PIN group/subgroup for PIN services. As another example, the routing information can include (a) a first set of IPv6 addresses with an IPv6 prefix of the UE with PEGC for non-PIN services and (b) a second set of IPv6 addresses with the same IPv6 prefix of the UE with PEGC for PIN services (e.g., using IPv6 subnet mask). (3) The UPF detects a TP packet (e.g., a PIN traffic) based on PDR and routes the detected IP packet based on the FAR to the destination UE with PEGC that serves the PIN group. (4) The UE with PEGC forwards the IP packets of a QoS flow towards PINEs within the PIN group.

FIGS. 20A and 20B are a messaging diagram 2000 of example process for PIN communication using framed routing.

At step 2022, the UE 102A, the AMF 364, the SMF 366, the UPF 370, and the UDM 308/UDR 352 perform a registration procedure with PIN communication capability support negotiation. More specifically, the UE 102A transmits to an AMF 364 a Registration Request message including PIN communication capability. The AMF 364 receives subscription information, related to PIN services, of the UE 102A from the Registration Request message. The AMF 364 then transmits to the UE 1104 a Registration Accept message. The Registration Accept message includes a PIN indication and PIN service information of the PIN 122A (e.g., maximum allowed number of PINEs of the PIN).

At step 2024, the UE 102A, the AMF 364, the SMF 366, the UPF 370, the UDM 308/UDR 352, and the AF 358 coordinate PIN communication configuration information. The UDM 308/UDR 352 stores the PIN communication configuration information (including PIN communication group data), as described with respect to at least some of FIGS. 7-19.

At step 2026, the UE 102A transmits to the AMF 364 a PDU Session Establishment Request message or a PDU Session Modification Request message. The message includes the PIN indication and/or a PIN ID associated with the PIN for the PDU session. The message may further include a PDU session ID, a Requested PDU Session Type, a Requested SSC mode, a 5GSM Capability, PCO, a SM PDU DN Request Container, a Number Of Packet Filters, a Header Compression Configuration, a UE Integrity Protection Maximum Data Rate, Always-on PDU Session Requested, RSN, Connection Capabilities, a PIN ID and/or a PDU Session Pair ID.

At step 2028, the AMF 364 transmits an Nsmf_PDUSession_CreateSMContext Request message to the SMF 366. The message includes the PIN indication and/or the PIN ID. At step 2030, the SMF 366 transmits an Nsmf_PDUSession_CreateSMContext Response message to the AMF 364.

Turning to FIG. 20B, at step 2032, the SMF 366 transmits an Nudm_SDM_Subscribe Request message to UDM 308/UDR 352. The message includes a UE ID of the UE 102A, a PIN indication and/or a PIN ID of the PIN 122A. At step 2034, the UDM 308/UDR 352 transmits an Nudm_SDM_Subscribe Response message to SMF 366. The message includes subscription data of a destination UE (e.g., the UE 102A) identified by SUPI or GPSI, and a destination PIN (e.g., the PIN 122A) identified by the PIN ID (e.g., an external group identifier).

Simultaneously with or after the steps 2032 and 2034, the SMF 366 performs a Session Management (SM) Policy Association and Modification procedure with the PCF 360 (not depicted) to obtain Policy Charging and Control (PCC) rules. The PCC rules include PIN service policies for the destination UE and the destination PINE.

Based on the subscription data received at step 2034 and the PCC rules, the SMF 366 (1) performs a QoS flow binding, (2) configures the UPF 370 via an N4 interface, and (3) transmits (at step 2036) an N4 Session Establishment Request message or an N4 Session Modification Request message to the UPF 370. The message includes (a) the PDR with destination group address information and (b) the FAR with routing information toward one or more destination UEs (PEGCs) (including the UE 102A) that serve PINEs of the PIN group. At step 2038, the UPF 370 acknowledges the request message by transmitting an N4 Session Establishment Response message or an N4 Session Modification Response message, corresponding to request message received at step 2036.

At step 2040, the SMF 366 transmits a message to the AMF 364. The message includes PIN communication configuration information, including (1) a PIN ID of the PIN that provides the PIN services, (2) a list of UE IDs of the Ues with PEGC (including the UE 102A) (as PIN group members), where the UE IDs are represented by GPSI, and (3) a list of logical interface IDs, i.e., the PINE IDs of PINEs in the PIN for each UE in the UE list (as PIN subgroup members). As an example, the list of logical interface IDs is a 64-bit value. As another example, the list of logical interface IDs is represented by a number of Ipv6 addresses. The Ipv6 addresses include information of the logical interface IDs in the last 64 bits or the first 64 bits of the Ipv6 addresses. The last or first 64 bits present an Ipv6 prefix for the PINEs. The last or first 64 bits may be the same as or different from an Ipv6 prefix for a UE with PEGC for non-PIN services.

At step 2042, the AMF 364 transmits to the UE 102A a PDU Session Establishment Response message or a PDU Session Modification Response message, corresponding to the request message received at step 2026. The response message includes the PIN communication configuration information.

FIG. 21 is a flow diagram 2100 of an example method, implemented by the SMF 366, for PIN communication using framed routing.

At block 2102, the SMF 366 receives a message from the UE 102A via the AMF 364, the message including a PIN indication and/or a PIN ID of the PIN 122A, as described with respect to steps 2026 and 2028.

At block 2104, the SMF 366 transmits a message to the URM 308/UDR 352, the message including a UE ID of the UE 102A, a PIN indication and/or a PIN ID of the PIN 122A, as described with respect to step 2032. At block 2016, the SMF 366 receives a message from the URM 308/UDR 352, the message including subscription data of a destination UE identified by SUPI or GPSI, and a destination PIN identified by the PIN ID, as described with respect to step 2034.

At block 2108, the SMF 366 performs a SM Policy Association and Modification procedure with the PCF 360 to obtain PCC rules, as described in connection with steps 2032 and 2034.

At block 2110, the SMF 366 to the UPF 370 a message, the message including destination group information and routing information toward one or more destination Ues (PEGCs) that serve PINEs of the PIN group, as described with respect to step 2036.

At block 2112, the SMF 366 transmits a message to the AMF 364, the message including PIN communication configuration information, as described with respect to step 2040.

It should be understood that the steps or blocks of the diagrams in FIGS. 7-21 do not need to be performed in the specific order as depicted. For example, in FIG. 17, step 1726 may be performed after step 1728. It should be understood that fewer or additional steps or blocks may be performed in the processes of FIGS. 7-21.

In the implementations where the UDM stores PIN communication configuration information, such information allows the 5G network to authorize PIN communication for PIN group members. The PIN communication configuration information includes PIN information, including (1) a PIN ID of the PIN and (2) a list of UEs with PEGC (as PIN members) that serve PINEs of the PIN. The UEs are identified by respective UE IDs, such as SUPI or GPSI.

As a PIN traffic needs to be routed to a UE in a specific PIN, the PIN ID is defined to uniquely identify the specific PIN in a PLMN. A PIN contains a group of UEs with PEGC as PIN members. As an example, a PIN ID is a local identifier, such as a network access identifier (NAI). In a global routable format (e.g., PIN_ID@domain), the domain needs to be a registered domain for global routing, and the PIN ID may be a static or dynamic identifier. Such an identifier is defined based on service level requirements between an AF and an operator's network. As another example, a PIN ID is an External Group Identifier. The AF may include an PIN service indication in the PIN ID to trigger a PIN service authorization check for an AF request (e.g., a request for PIN service parameters provisioning for destination PIN groups) at the UDM.

In some implementations, a PIN is a VN group. In such implementations, a PIN is identified an External Group Identifier, and each PIN member is a VN group member identified by GPSI.

As a PIN may include PINEs served by a UE with PEGC using IP-based connectivity (e.g., Wi-Fi) or non-IP-based connectivity (e.g., Bluetooth), a new addressing mechanism is needed. The new addressing mechanism is different from IP-based LAN type service, which does not need to store the configuration of the devices connected to the serving UE.

In order to differentiate a VN group for LAN-type services from a VN group for PIN services, the UDM may configure an indication to indicate the type of the VN group. Table 1 below illustrates example information stored by a UDM. As shown, the UDM stores an indication for a type of the VN group. The indication for the type of the VN group indicates whether the N group is for LAN-type service or for PIN services.

TABLE 1

| Parameters | Description |
|---|---|
| List of GPSI | List of 5G VN Group members, each member |
| | is identified by GPSI |
| External Group ID | An identifier for 5G VN group |
| Type of 5G VN Group | 5G LAN type or PIN |

VN group data of the VN group may further include service types allowed for the VN group. Table 2 below shows example VN group data description. The VN group data description includes a parameter of VN group type. The parameter indicates service types allowed for the VN group or the PIN group.

TABLE 2

| Parameters | Description |
|---|---|
| DNN | DNN for the 5G VN group |
| S-NSSAI | S-NSSAI for the 5G VN group |
| PDU Session Type | PDU Session Types allowed for 5G VN group |
| 5G VN Group Type | Service Types allowed for 5G VN group or |
| | PIN group |
| Application descriptor | There may be multiple instances of this |
| | information; this information may be used to |
| | build URSP sent to 5G VN group members |
| . . . | . . . |

In some implementations, PINEs connected with UEs with PEGC are identified to support PIN traffic routing from a first PINE to a second PINE. In some implementations, the UE connected to the first PINE may be the same as or different from the UE connected to the second PINE.

The UDM may store PIN subgroup information. The PIN subgroup information includes information of a group of PINEs associated with the PIN served by the UE with PEGC. The PIN subgroup information includes (1) a UE ID of the UE with PEGC and (2) a list of PINEs. The PINEs in the list are served by the UE using IP-based connectivity or non-IP-based connectivity. Table 3 below illustrates example information that the UDM may store to extend PIN group information.

TABLE 3

| Parameters | Description |
|---|---|
| List of PINEs as PIN | List of PINEs identified by PINE ID and |
| subgroup members | connected to the UE with PEGC identified by |
| associated to the UE ID | the UE ID. |
| UE ID | SUPI or GPSI |

In some implementations, for PIN service, an AF provide PIN subgroup information, as illustrated in Table 4 below.

TABLE 4

| Parameters | Description |
|---|---|
| PIN Subgroup or one or | List of PIN subgroup ID, each subgroup is |
| more group of PINEs | identified by internal group identifier, or |
| | represented by a list of PINE IDs per |
| | subgroup |
| GPSI | An identifier for PEGC as 5G VN group |
| | member |

In some implementations, the URSP includes information illustrated in Table 5 below.

TABLE 5

| | | | PCF | |
|---|---|---|---|---|
| Informa- | | | permitted to | |
| tion | | | modify in a | |
| name | Description | Category | UE context | Scope |
| . . . | . . . | . . . | . . . | . . . |
| PIN ID | Matched against a | Optional | Yes | UE |
| | PIN ID for a specific | | | context |
| | PIN configured in the | | | |
| | PEGC. (NOTE 9) | | | |
| PIN | Matched against a PIN | Optional | Yes | UE |
| subgroup | subgroup ID for a | | | context |
| ID | specific PIN configured | | | |
| | in the PEGC. (NOTE 9) | | | |
| . . . | | | | |

(NOTE 9):
Only applies to traffic to/from PINEs. PIN ID/PIN subgroup ID and other traffic descriptor components are mutually exclusive, i.e. if PIN ID/PIN subgroup ID is included in a URSP rule, then no other traffic descriptor components are supported in the same URSP rule.

In some implementations, the URSP includes information illustrated in Table 6 below.

TABLE 6

| | | | PCF | |
|---|---|---|---|---|
| | | | permitted | |
| Information | | | to modify | |
| name | Description | Category | in URSP | Scope |
| . . . | . . . | . . . | . . . | . . . |
| PDU Session | One single value of | Conditional | Yes | UE |
| Type | PDU Session Type | | | context |
| Selection | | | | |
| PDU Session | One single value of | Conditional | Yes | UE |
| Type | PDU Session Type | | | context |
| Selection | | | | |
| PDU Session | An indication to | Conditional | Yes | UE |
| ID or PIN ID | associate PDU | (NOTE 10) | | context |
| Selection | Session for a PIN. | | | |
| . . . | | | | |

(NOTE 10):
Only applies to traffic to/from PINEs.

The PDU Session ID/PIN ID Selection parameters indicate that the PIN traffic of matching PIN ID shall be routed via a PDU Session associated to the included PDU Session ID or PIN ID.

In the implementations where a UE request includes a PIN ID, the SMF obtains PIN group information.

The following list of examples reflects a variety of the embodiments explicitly contemplated by the present disclosure:
Example 1. A method implemented in a user equipment (UE), the method comprising: serving a personal internet-of-things (IoT) network (PIN) element (PINE) associated with a PIN, to provide a direct connection between the PINE and the UE operating as a PINE with gateway capability (PEGC), receiving, at the UE via a core network (CN), an Internet Protocol (IP) packet; and routing the IP packet to the PINE in view of a header of the IP packet.
Example 2. The method of example 1, wherein the routing includes determining a PINE identifier (ID) based on the header.
Example 3. The method of example of 1 or 2, further comprising: retrieving, from the header, an interface ID of the PINE; and determining a mapping between the interface ID and a Medium Access Control (MAC) address of the PINE; wherein the routing of the IP packet is based on the MAC address of the PINE.
Example 4. The method of example of 3, wherein the determining of the mapping includes using a hash function.
Example 5. The method of example of 3, wherein the determining of the mapping includes using a mapping table stored in a memory of the UE.
Example 6. The method of example of 3, wherein the interface ID includes the MAC address of the PINE and a predefined value.
Example 7. The method of example of 3, wherein the interface ID includes a hash of the MAC address of the PINE and a predefined value.
Example 8. The method of example 6 or 7, wherein: the interface ID is a 64-bit field; and the MAC address is a 48-bit field.
Example 9. The method of example 6, wherein the MAC address is in a middle of the interface ID, between a first portion of the predefined value and a second portion of the predefined value.
Example 10. The method of clam 6, wherein the interface ID is a randomly generated value.
Example 11. The method of any of the preceding examples, wherein the header is an IPv6 header.
Example 12. The method of example 11, wherein: a source address field of the IPv6 header indicates an IPv6 address of a source PINE that originated the IP packet.
Example 13. The method of example 11 or 12, wherein: a destination address field of the IPv6 header indicates an IPv6 address of the PINE.
Example 14. The method of any of examples 11-13, wherein: an extension header field of the IPv6 header indicates an ID of the PIN.
Example 15. The method of example 11, wherein: a source address field of the IPv6 header indicates an IPv6 address of a source UE with PEGC, which transmitted the IP packet.
Example 16. The method of example 11 or 15, wherein: a destination address field of the IPv6 header indicates an IPv6 address of the UE.
Example 17. The method of example 11, 15, or 16, wherein: an extension header field of the IPv6 header indicates (i) an ID of the PIN, (ii) a PINE ID of the source PINE that originated the IP packet, and (iii) a PINE ID of the PINE.
Example 18. The method of example 1 or 2, further comprising: transmitting, to the CN, a PIN communication configuration for routing the IP packet via the CN.
Example 19. The method of example 18, wherein the transmitting of the PIN communication configuration includes: using user-plane traffic to transmit the PIN communication configuration to an Application Function (AF).
Example 20. The method of example 19, further comprising: using an uplink (UL) non-access stratum (NAS) message to transmit the PIN communication configuration to a Unified Data Management Function.
Example 21. The method of any of examples 18-20, further comprising: receiving an interface ID from the PINE using a Neighbor Discovery protocol; and using the interface ID to generate a PINE ID.
Example 22. The method of any of examples 18-20, further comprising: generating a logical interface ID for the PINE, to uniquely identify the PINE within a PIN subgroup of the PEGC; and using the logical interface ID to generate a PINE ID.
Example 23. The method of example 21 or 22, further comprising: generating an interface ID for the PINE; and including, in the PIN communication configuration: a PIN ID to identify the PIN, a UE ID to identify the UE, and the PINE ID.
Example 24. The method of example 23, where the UE ID incudes a Generic Public Subscription Identifier (GPSI)
Example 25. The method of example 23, wherein: the PIN communication configuration includes a list of PINE ID corresponding to respective PINEs of a PIN subgroup associated with the PEGC.
Example 26. The method of example 1 or 2, further comprising: receiving, from the CN, a PIN communication configuration for routing the IP packet.
Example 27. The method of example 26, wherein the PIN communication configuration includes: (i) a PIN ID to identify the PIN, (ii) a UE ID to identify the UE, and (iii) a PINE ID to identify the PINE within a PIN subgroup of the PEGC.
Example 28. The method of example 26 or 27, further comprising: generating, using the PIN communication configuration, a mapping table to map the PINE ID to a MAC address of the PINE.
Example 29. The method of any of examples 26-28, wherein: the PIN communication configuration is received from a Unified Data Management Function (UDM) or an Access and Mobility Management Function (AMF).
Example 30. The method of any of examples 26-28, wherein: the PIN communication configuration is received from an Application Function (AF).
Example 31. A user equipment (UE), comprising a transceiver and processing hardware, the UE configured to implement a method of any of the preceding examples.
Example 32. A method implemented in a network function (NF) of a core network (CN), the method comprising: receiving, at the NF, a personal internet-of-things (IoT) network (PIN) communication configuration including (i) an identifier of a PIN, (ii) a UE ID to identify a user equipment (UE) operating as a PIN element (PINE) with gateway capability (PEGC) and associated with the PIN, and (iii) a PINE ID to identify the PINE within a PIN subgroup of the PEGC; and configuring the CN for routing IP packets addressed to the PINE.
Example 33. The method of example 32, wherein: the NF is an Application Function (AF), and the PIN communication configuration is received from the UE.
Example 34. The method of example 33, further comprising: configuring a Unified Data Management Function (UDM) with the PIN communication configuration.
Example 35. The method of example 32, wherein: the NF is an AF, and the PIN communication configuration is received from a UDM.
Example 36. The method of example 35, wherein: the PIN communication configuration is received from the UDM via an event exposure notification.
Example 37. The method of example 35 or 36, wherein: the PINE ID included in the PIN communication configuration is generated at the UDM as an interface ID.
Example 38. The method of any of examples 35-37, further comprising: transmitting the PIN communication configuration to the UE.
Example 39. The method of any of examples 35-37, wherein: the PIN communication configuration is transmitted to the UE by the UDM.
Example 40. The method of example 32, wherein: the NF is a UDM, and the PIN communication configuration is received from the AF.
Example 41. The method of 40, wherein: the PIN communication configuration is received from the AF via a Network Exposure Function (NEF).
Example 42. The method of example 40 or 41, wherein: the AF provisions the UE using a NAS procedure.
Example 43. The method of example 32, wherein: the NF is a UDM, and the PIN communication configuration is received from the UE.
Example 44. The method of example 42, wherein: the PIN communication is received from the UE via an Access and Mobility Management Function (AMF).
Example 45. The method of any of examples 32-44, further comprising: providing the PIN communication configuration to a Session Management Function (SMF) for configuring rules for routing IP traffic to the PINE.
Example 46. A device comprising processing hardware, the device configured to implement a network function (NF) of a core network (CN) of a cellular communication system, the NF configured to implement a method of any of examples 32-45.

What is claimed is:

1. A method implemented in a user equipment (UE), the method comprising:
serving a personal internet-of-things (IoT) network (PIN) element (PINE) associated with a PIN, to provide a direct connection between the PINE and the UE operating as a PINE with gateway capability (PEGC);
receiving, at the ULE via a core network (CN), an Internet Protocol (IP) packet; and
routing the IP packet to the PINE in view of a header of the IP packet.

2. The method of claim 1, wherein the routing includes determining a PINE identifier (ID) based on the header.

3. The method of claim of 1 or 2, further comprising:
retrieving, from the header, an interface ID of the PINE; and
determining a mapping between the interface ID and a Medium Access Control (MAC) address of the PINE; wherein
the routing of the IP packet is based on the MAC address of the PINE.

4. The method of any of claims 1-3, wherein the header is an IPv6 header.

5. The method of claim 4, wherein:
a source address field of the IPv6 header indicates an IPv6 address of a source PINE that originated the IP packet.

6. The method of claim 4, wherein:
a source address field of the IPv6 header indicates an IPv6 address of a source UE with PEGC, which transmitted the IP packet.

7. The method of claim 1 or 2, further comprising:
transmitting, to the CN, a PIN communication configuration for routing the IP packet via the CN.

8. The method of claim 1 or 2, further comprising:
receiving, from the CN, a PIN communication configuration for routing the IP packet.

9. A user equipment (UE), comprising a transceiver and processing hardware, the UE configured to implement a method of any of the preceding claims.

10. A method implemented in a network function (NF) of a core network (CN), the method comprising:
receiving, at the NF, a personal internet-of-things (IoT) network (PIN) communication configuration including (i) an identifier of a PIN, (ii) a UE ID to identify a user equipment (UE) operating as a PIN element (PINE) with gateway capability (PEGC) and associated with the PIN, and (iii) a PINE ID to identify the PINE within a PIN subgroup of the PEGC; and
configuring the CN for routing IP packets addressed to the PINE.

11. The method of claim 10, wherein:
the NF is an Application Function (AF), and
the PIN communication configuration is received from the UE as user-plane data.

12. The method of claim 11, further comprising:
configuring a Unified Data Management Function (UDM) with the PIN communication configuration.

13. The method of claim 10, wherein:
the NF is an AF, and
the PIN communication configuration is received from a UDM.

14. The method of claim 10, wherein:
the NF is a UDM, and
the PIN communication configuration is received from the AF.

15. The method of any of claims 11-14, further comprising:
providing the PIN communication configuration to a Session Management Function (SMF) for configuring rules for routing IP traffic to the PINE.
